(19) United States
(12) Patent Application Publication
(10) Pub. No.: US 2026/0370760 A1
(43) Pub. Date: Nov. 19, 2026

(54) System and Method for Parameter-Driven Dynamic Landing Page Communication Orchestration

(71) Applicant: TapText llc, Coral Springs, FL (US)

(72) Inventors: Steve Doumar, Fort Lauderdale, FL (US); Brian Galvin, Silverdale, WA (US)

(21) Appl. No.: 19/750,394

(22) Filed: Jul. 22, 2026

Related U.S. Application Data
(63) Continuation-in-part of application No. 19/696,642, filed on Jun. 3, 2026.
Application No. 19/696,642 is a continuation-in-part of application No. 19/683,929, filed on May 21, 2026.
Application No. 19/683,929 is a continuation-in-part of application No. 19/441,824, filed on Jan. 6, 2026.
Application No. 19/441,824 is a continuation of application No. 17/874,209, filed on Jul. 26, 2022, now Pat. No. 12,519,888.
Application No. 17/874,209 is a continuation-in-part of application No. 17/865,814, filed on Jul. 15, 2022, now Pat. No. 12,211,070.
Application No. 17/865,814 is a continuation-in-part of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
Application No. 17/209,474 is a continuation-in-part of application No. 17/208,059, filed on Mar. 22, 2021, now Pat. No. 11,562,407.
Application No. 17/208,059 is a continuation-in-part of application No. 17/191,977, filed on Mar. 4, 2021, now abandoned.
Application No. 17/191,977 is a continuation-in-part of application No. 17/190,260, filed on Mar. 2, 2021, now Pat. No. 11,532,020.
Application No. 17/190,260 is a continuation-in-part of application No. 17/153,426, filed on Jan. 20, 2021, now abandoned.
Application No. 19/696,642 is a continuation-in-part of application No. 18/631,042, filed on Apr. 10, 2024, now Pat. No. 12,657,570.
Application No. 18/631,042 is a continuation-in-part of application No. 18/593,911, filed on Mar. 3, 2024, now Pat. No. 12,182,794.
Application No. 18/593,911 is a continuation-in-part of application No. 18/185,993, filed on Mar. 17, 2023, now Pat. No. 11,995,639.
Application No. 18/185,993 is a continuation of application No. 17/409,841, filed on Aug. 24, 2021, now Pat. No. 11,610,193.
Application No. 17/409,841 is a continuation-in-part of application No. 17/360,731, filed on Jun. 28, 2021, now Pat. No. 11,871,308.
Application No. 17/360,731 is a continuation-in-part of application No. 17/229,251, filed on Apr. 13, 2021, now abandoned.
Application No. 17/229,251 is a continuation-in-part of application No. 17/085,931, filed on Oct. 30, 2020, now Pat. No. 11,055,736.
(63) Continuation-in-part of application No. 18/407,340, filed on Jan. 8, 2024, now Pat. No. 12,696,055.
Application No. 18/407,340 is a continuation of application No. 17/360,731, filed on Jun. 28, 2021, now Pat. No. 11,871,308.
(60) Provisional application No. 63/154,357, filed on Feb. 26, 2021.
(60) Provisional application No. 63/166,391, filed on Mar. 26, 2021.
(60) Provisional application No. 63/211,496, filed on Jun. 16, 2021.
(60) Provisional application No. 63/519,562, filed on Aug. 14, 2023.
(60) Provisional application No. 63/519,559, filed on Aug. 14, 2023.

(51) Int. Cl. H04M 3/51; H04L 51/02; H04M 1/72436

(52) U.S. Cl. CPC H04M 3/5191; H04L 51/02; H04M 1/72436

(57) ABSTRACT

A system and method for parameter-driven dynamic landing page communication orchestration is disclosed. A landing page endpoint receives requests comprising one or more runtime parameters including campaign identifiers, product identifiers, validation tokens, client identifiers, or user-associated identifiers. A landing-page runtime service interprets the parameters, retrieves contextual records and rule sets, and dynamically composes the page by selecting templates, inserting content fragments, rendering controls, and binding actions based on the interpreted state. The same endpoint supports multiple distinct flows without requiring separate hard-coded pages. Page-rendered controls initiate communications, validation sequences, scheduling actions, or downstream routing events governed by identity-linked records, permission states, and channel-eligibility determinations. Session identifiers preserve continuity across page interactions, messaging handoffs, and protocol transitions. The system enables white-label deployments wherein multiple clients share a common runtime infrastructure while maintaining client-specific branding, templates, rule sets, and destination mappings.

### CROSS-REFERENCE TO RELATED APPLICATIONS

Priority is claimed in the application data sheet to the following patents or patent applications, each of which is expressly incorporated herein by reference in its entirety:
Ser. No. 19/696,642
Ser. No. 19/683,929
Ser. No. 19/441,824
Ser. No. 17/874,209
Ser. No. 17/865,814
Ser. No. 17/229,251
63/166,391
Ser. No. 17/209,474
Ser. No. 17/208,059
Ser. No. 17/191,977
Ser. No. 17/190,260
Ser. No. 17/153,426
63/154,357
Ser. No. 18/631,042
Ser. No. 18/593,911
63/519,562
Ser. No. 18/185,993
Ser. No. 17/409,841
Ser. No. 17/360,731
Ser. No. 17/085,931
63/211,496
63/519,559
Ser. No. 18/407,340

### BACKGROUND OF THE INVENTION

### Field of the Art

The present invention relates to the field computer-based communication systems, and more specifically to dynamic content presentation to users based on multi-factor identification methods.

### Discussion of the State of the Art

Conventional landing pages are typically static or minimally personalized web destinations associated with campaigns, products, or advertisements. Such pages generally present fixed content and controls to all visitors, regardless of request context, user identity, permission state, or intended interaction path. Even where landing pages incorporate limited parameter-based variation, such variation is often cosmetic rather than functional, affecting displayed text or imagery without altering available actions, communication pathways, or downstream routing logic.

Existing systems do not generally treat a landing page as a programmable runtime execution surface capable of selecting among multiple distinct interaction flows based on request-time parameters and retrieved contextual records. Instead, different interaction experiences typically require separately engineered pages, separately provisioned URLs, or separately maintained code branches. As the number of campaigns, clients, products, and user scenarios increases, this approach leads to page proliferation, increased deployment overhead, maintenance burden, and reduced operational flexibility.

Furthermore, conventional landing pages do not dynamically determine which controls should be rendered, which actions are permitted, or which communication channels are eligible based on identity-linked records, permission states, and technical capabilities. A page may present a generic contact button, but the button is not typically bound at runtime to different backend actions, different downstream destinations, or different protocol-specific communication paths depending on who the user is, what permissions apply, or what channel capabilities exist.

Existing systems also lack robust mechanisms for preserving session continuity when a landing-page interaction transitions into a messaging flow, downstream system handoff, or protocol fallback scenario. Page interactions and subsequent communications are often treated as weakly related events rather than as continuous threads linked by session identifiers and shared contextual state.

White-label and multi-tenant deployments present additional challenges. Platform operators seeking to support multiple clients with distinct branding, terminology, templates, and routing logic often resort to duplicating page infrastructure or maintaining separate codebases for each client, rather than leveraging a shared runtime substrate with client-specific configuration overlays.

Accordingly, what is needed is a system in which a single landing page endpoint, or a limited family of endpoints, can support multiple distinct and dynamically determined interaction flows based on runtime parameters, retrieved context, identity and permission determinations, and channel-eligibility assessments, while preserving session continuity and enabling efficient white-label deployment.

### SUMMARY OF THE INVENTION

According to a preferred embodiment, a system for parameter-driven dynamic landing page communication orchestration, comprising: one or more computing devices configured to: receive a page request from a user device, wherein the page request comprises one or more runtime parameters selected from the group consisting of campaign identifiers, product identifiers, validation tokens, client identifiers, user-associated identifiers, transaction-linked identifiers, and session identifiers; interpret the one or more runtime parameters by resolving said parameters into runtime associations comprising at least one of campaign associations, product contexts, client-specific configurations, validation states, or user-linked records through retrieval of corresponding records from one or more datastores; dynamically compose a landing page by selecting a page template, inserting content fragments based on the runtime associations, applying branding assets according to client-specific configuration, rendering one or more interactive controls appropriate for the runtime associations, and binding the one or more interactive controls to backend actions according to applicable rule sets, wherein the dynamically composed landing page varies based on the runtime parameters while being served from a single landing page endpoint; determine whether page-triggered actions are authorized by evaluating permission states and opt-in status associated with user identity profiles; assess available communication channels based on device capability, carrier support, and protocol availability; assign session identifiers linking page requests, user interactions, communication launches, and downstream routing events into persistent session records; initiate communications over selected channels based on permission determinations and channel availability assessments, wherein communications preserve session context through embedded session identifiers; and route page-triggered interactions to downstream systems with session identifiers, campaign attribution data, and user context; wherein the one or more computing devices are configured to support multiple distinct interaction flows from the single landing page endpoint by determining runtime page behavior based on the runtime associations, retrieved contextual records, permission determinations, and channel eligibility assessments, thereby enabling a shared technical infrastructure to serve multiple campaigns, clients, and user contexts without requiring separate hard-coded landing pages for each interaction scenario.

According to another preferred embodiment, a method for parameter-driven dynamic landing page communication orchestration, comprising the steps of: receiving a page request from a user device, wherein the page request comprises one or more runtime parameters selected from the group consisting of campaign identifiers, product identifiers, validation tokens, client identifiers, user-associated identifiers, transaction-linked identifiers, and session identifiers, using a computing device; interpreting the one or more runtime parameters by resolving said parameters into runtime associations comprising at least one of campaign associations, product contexts, client-specific configurations, validation states, or user-linked records through retrieval of corresponding records from one or more datastores, using a computing device; dynamically composing a landing page by selecting a page template, inserting content fragments based on the runtime associations, applying branding assets according to client-specific configuration, rendering one or more interactive controls appropriate for the runtime associations, and binding the one or more interactive controls to backend actions according to applicable rule sets, wherein the dynamically composed landing page varies based on the runtime parameters while being served from a single landing page endpoint, using a computing device; determining whether page-triggered actions are authorized by evaluating permission states and opt-in status associated with user identity profiles, using a computing device; assessing available communication channels based on device capability, carrier support, and protocol availability, using a computing device; assigning session identifiers linking page requests, user interactions, communication launches, and downstream routing events into persistent session records, using a computing device; initiating communications over selected channels based on permission determinations and channel availability assessments, wherein communications preserve session context through embedded session identifiers, using a computing device; routing page-triggered interactions to downstream systems with session identifiers, campaign attribution data, and user context, using a computing device; and supporting multiple distinct interaction flows from the single landing page endpoint by determining runtime page behavior based on the runtime associations, retrieved contextual records, permission determinations, and channel eligibility assessments, thereby enabling a shared technical infrastructure to serve multiple campaigns, clients, and user contexts without requiring separate hard-coded landing pages for each interaction scenario, using a computing device.

### BRIEF DESCRIPTION OF THE DRAWING FIGURES

FIG. 1 is a system diagram illustrating an exemplary architecture for parameter-driven dynamic landing page communication orchestration according to a preferred embodiment.

FIG. 2 is a method diagram illustrating the receipt and processing of a landing page request comprising one or more query-string parameters, path parameters, tokens, or other runtime request values according to a preferred embodiment.

FIG. 3 is a block diagram illustrating the operation of a parameter interpretation engine configured to resolve one or more request parameters into one or more campaign associations, product associations, validation associations, client-specific configurations, or executable page states according to a preferred embodiment.

FIG. 4 is a block diagram illustrating dynamic page composition using one or more page templates, content fragments, widget definitions, control bindings, and runtime configuration records according to a preferred embodiment.

FIG. 5 is a method diagram illustrating page-load flow selection based on request parameters and one or more retrieved rule sets according to a preferred embodiment.

FIG. 6 is a method diagram illustrating the initiation of one or more secondary or subsequent flows through user interaction with one or more dynamically rendered page controls according to a preferred embodiment.

FIG. 7 is a system diagram illustrating the integration of the landing-page orchestration layer with one or more identity services, opt-in or permission services, and channel-eligibility services according to a preferred embodiment.

FIG. 8 is a sequence diagram illustrating capability-aware communication initiation from a dynamically rendered page control according to a preferred embodiment.

FIG. 9 is a method diagram illustrating page-triggered routing to one or more downstream destinations including agent systems, messaging services, customer relationship management systems, or validation services according to a preferred embodiment.

FIG. 10 is a data structure diagram illustrating associations among request parameters, campaign records, user-associated records, template identifiers, control definitions, session identifiers, and flow rules according to a preferred embodiment.

FIG. 11 is a system diagram illustrating a white-label deployment architecture in which multiple clients use a shared landing-page runtime with client-specific branding, templates, and rule sets according to a preferred embodiment.

FIG. 12 is a method diagram illustrating preservation of session continuity across landing-page interaction, messaging handoff, and protocol fallback according to a preferred embodiment.

FIG. 13 is a method diagram illustrating identity-linked and validation-linked parameter resolution using one or more identifiers including phone number, transaction-linked identifier, validation token, or user-associated record references according to a preferred embodiment.

FIG. 14 is a system diagram illustrating exemplary downstream integrations including analytics, loyalty, customer relationship management, scheduling, messaging, and external application programming interface systems according to a preferred embodiment.

FIG. 15 illustrates an exemplary computing environment on which an embodiment described herein may be implemented.

### DETAILED DESCRIPTION OF THE INVENTION

The inventor has conceived and reduced to practice a system and method for parameter-driven dynamic landing page communication orchestration. The disclosed invention enables a landing page endpoint to function not merely as a passive content destination, but as a programmable runtime execution surface whose behavior, content, available actions, and downstream integrations are determined dynamically based on one or more request-time parameters and one or more retrieved contextual records. Unlike conventional landing page systems wherein different interaction scenarios require separate hard-coded pages or separately provisioned URLs, the disclosed system enables a single landing page endpoint, or a limited family of template endpoints, to support multiple distinct and context-aware interaction flows through runtime interpretation of parameter values and synthesis of those values with stored campaign records, user profiles, permission states, validation records, and business rules.

In preferred embodiments, a request directed to a landing page comprises one or more parameters conveyed through query strings, path segments, tokens, cookies, headers, or other request-associated mechanisms. These parameters may include campaign identifiers linking the request to specific marketing or operational initiatives, product identifiers specifying which offerings or services are the subject of the interaction, validation tokens referencing pending identity verification or approval requirements, client identifiers indicating which white-label client is making the request, user-associated identifiers such as phone numbers or account references that resolve to persistent user profiles, transaction-linked identifiers connecting the request to specific business transactions, session identifiers maintaining continuity with prior interactions, or other runtime values encoding context about why the request is being made and what circumstances surround it. A parameter interpretation engine receives these parameter values, validates their authenticity and currency, normalizes them into canonical representations, and resolves them into rich contextual associations by retrieving corresponding records from datastores. A campaign identifier resolves to a campaign record containing flow rules, messaging guidelines, and destination mappings. A user identifier resolves to a user profile containing interaction history, opt-in states, and permission levels. A validation token resolves to a validation record indicating what gating conditions apply and whether they have been satisfied. Through this resolution process, simple parameter strings are transformed into comprehensive contextual intelligence that will govern all subsequent page composition and action processing decisions.

The resolved parameter associations, together with retrieved contextual records and applicable rule sets, are synthesized into a runtime page state object that serves as a complete specification of how the landing page should be composed and what actions should be available. A page composition engine consults this runtime page state object to select an appropriate page template from a library of reusable templates, insert relevant content fragments into template regions based on campaign messaging and product context, apply client-specific branding assets including logos, color schemes, and terminology to support white-label deployment, render interactive controls such as buttons, widgets, forms, and message launchers that are appropriate for the current flow mode and permission state, and bind those controls to backend action handlers according to the campaign rules and user authorization levels encoded in the runtime page state. The resulting dynamically composed landing page reflects the synthesis of all interpreted parameters and retrieved context, presenting content, controls, and branding specifically tailored to the request circumstances while being constructed from reusable components rather than retrieved as a pre-authored static artifact.

The disclosed system integrates the landing page orchestration layer with identity services that maintain persistent user profiles anchored to stable identifiers such as phone numbers, permission services that enforce opt-in states and consent scopes across all user interactions, and channel eligibility services that assess device capabilities and protocol support to determine which communication channels are technically feasible. When a user activates a control rendered on the dynamically composed page, the landing page runtime service evaluates whether the requested action is authorized by querying permission services for the current user's opt-in state, determines which communication channel or downstream system should receive the interaction by applying campaign rules and capability assessments, constructs appropriately formatted communications or routing events that preserve session context and attribution data, and updates session records to maintain continuity across page interactions, messaging handoffs, and downstream system engagements. This integrated architecture ensures that landing pages do not merely present information but actively orchestrate multi-system workflows while respecting permission constraints and adapting to technical capabilities.

Session continuity is preserved through persistent session identifiers that link together initial page requests, user interactions with rendered controls, communications launched from those interactions, downstream routing events, protocol fallback adaptations when initial communication channels fail, and follow-on user responses that may arrive hours or days after the initial page visit. The session identifier serves as a durable thread connecting all related activities across multiple surfaces, systems, and temporal gaps, enabling the platform to maintain coherent interaction histories, attribute downstream business outcomes to originating landing page sessions, and provide consistent user experiences even when interactions traverse boundaries between web pages, messaging channels, agent platforms, and external business systems. This session-based continuity architecture transforms landing pages from isolated web destinations into persistent orchestration hubs for extended multi-channel user journeys.

The disclosed system supports white-label and multi-tenant deployment wherein multiple clients share a common landing page runtime infrastructure while receiving client-specific branding, templates, business rules, and system integrations. Client-specific configurations stored as data records rather than hard-coded in application logic enable rapid client onboarding, flexible customization of client experiences, and consistent platform evolution wherein all clients benefit simultaneously from core infrastructure improvements while maintaining their distinct brand identities and operational preferences. This white-label architecture enables platform operators to serve multiple clients without linear scaling of development and maintenance costs, while enabling clients to present landing page experiences that appear fully native to their brands and seamlessly integrated with their specific downstream business systems.

The comprehensive integration architecture connects the landing page orchestration layer with analytics platforms for event tracking and attribution measurement, customer relationship management systems for lead capture and opportunity management, messaging gateways for multi-protocol communication delivery, scheduling systems for appointment booking and callback coordination, loyalty platforms for rewards program integration, validation services for identity verification and approval workflows, agent platforms for human-assisted interaction routing, and external API systems supporting diverse industry-specific or client-custom integrations. Each integration preserves rich contextual data flowing from landing page sessions to downstream systems, ensuring that those systems receive not merely notification of user actions but comprehensive campaign attribution, user profile enrichment, permission state information, and session linkage enabling accurate measurement of landing page contribution to business outcomes and intelligent processing of interactions with full awareness of their originating context.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “runtime parameter” refers to a value associated with a landing page request, conveyed through query strings, path segments, tokens, cookies, headers, or other request-associated mechanisms, that is interpreted at the moment the request is received to determine the behavior, content, and available actions of the dynamically composed page. A runtime parameter is not a configuration setting baked into application code or a static attribute of the page template itself, but rather an input value that varies from request to request and that drives the parameter interpretation engine to retrieve corresponding contextual records and resolve an appropriate page state. Runtime parameters in the disclosed system include campaign identifiers, product identifiers, validation tokens, client identifiers, user-associated identifiers, transaction-linked identifiers, and session identifiers, each of which resolves through datastore lookups to a distinct category of contextual association. The defining characteristic of a runtime parameter, as used herein, is that its interpretation produces executable page state rather than mere cosmetic variation: a runtime parameter governs which controls are rendered, which actions are permitted, which communication channels are eligible, and which downstream systems will receive page-triggered interactions, not merely which text strings or images are displayed.

As used herein, “runtime page state object” refers to a structured data object produced by the parameter interpretation and context retrieval process that serves as a complete specification of how a dynamically composed landing page should be assembled and what actions should be available at the time of a given request. The runtime page state object is not a pre-authored page document, a cached rendering artifact, or a static template, but rather an ephemeral object constructed on demand by synthesizing resolved parameter associations, retrieved campaign records, user profiles, permission states, validation records, and applicable rule sets into a single coherent representation. The runtime page state object carries the selected template identifier, the set of content fragments to insert into template regions, the branding profile to apply, the list of controls to render along with their configurations and bindings, the permission constraints governing each control, channel eligibility determinations affecting communication actions, and the flow rules determining how user interactions should be processed. Downstream operations within the landing page runtime service—including page composition, widget instantiation, control binding, and action routing—operate against the runtime page state object as their authoritative input, ensuring that all aspects of page behavior for a given request are derived from a single consistent source rather than from disparate lookups performed at different stages of the rendering pipeline.

As used herein, “channel eligibility assessment” refers to the process by which the system evaluates the technical feasibility and availability of one or more communication protocols for a given user, device, and carrier environment at the time of a page request or control activation event. A channel eligibility assessment is not a static lookup of user preferences or a blanket assumption about device capabilities, but rather a dynamic evaluation that considers device type and capability, carrier support for advanced messaging protocols such as Rich Communication Services (“RCS”), message platform availability, application environment characteristics, network conditions, and historical delivery success associated with prior interactions involving the same identifier. The channel eligibility assessment produces a ranked or filtered set of available communication pathways—which may include SMS, MMS, RCS, email, web-based messaging, application-based messaging, or masked relay channels—along with determinations about whether richer or fallback protocols should be employed. The result of the channel eligibility assessment governs which communication controls are rendered on the dynamically composed page, what channel is selected when a communication control is activated, and whether fallback protocol adaptation is required if initial delivery fails. Channel eligibility assessments are performed both at page composition time, to determine which controls to render, and at action execution time, to confirm that selected channels remain technically viable at the moment of communication initiation.

As used herein, “permission-gated control” refers to an interactive page element—such as a button, widget, form, or message initiator—whose availability, active state, or executable behavior on a dynamically composed landing page is conditioned upon the current authorization state of the requesting user as determined by querying an identity and permission service at page composition time. A permission-gated control is distinct from a universally available control in that its rendering, labeling, and binding may vary based on opt-in state, consent scope, and authorization level associated with the user's persistent identity profile: the same control definition may render as an active communication launcher for a user with full opt-in, as a disabled or visually suppressed element for a user with no applicable consent on record, or as a validation-collection prompt for a user whose consent requires additional confirmation before communication can proceed. Permission gating applies not only at initial page composition but also at the moment of control activation, where the system re-queries the permission service to confirm that authorization remains valid before executing the bound action, thereby preventing scenarios where a page rendered with valid permission is subsequently activated after that permission has been revoked. The permission-gated nature of rendered controls is a defining architectural property of the disclosed system that distinguishes it from conventional landing pages in which interactive elements are universally present and their executability is determined only by error handling at the backend rather than by proactive authorization evaluation at composition and activation time.

As used herein, “session identifier” refers to a persistent, unique value assigned to a page interaction at the time of an initial landing page request that links together all subsequent interactions, communications, downstream routing events, and follow-on user responses arising from that originating request into a single coherent session record. A session identifier in the disclosed system is not limited in function to maintaining state within a single web browsing session or to correlating HTTP requests from the same browser tab, but rather serves as a durable cross-surface thread that preserves interaction continuity when a page-initiated engagement transitions into a messaging flow, agent handoff, protocol fallback, or external business system routing event. The session identifier is embedded within outbound communications as message metadata, transmitted with downstream routing events as attribution linkage, and stored in session records that accumulate a chronological log of all interactions within the session regardless of which channel or system those interactions traverse. The session identifier enables the platform to maintain coherent interaction histories spanning landing page visits, messaging exchanges, agent engagements, and downstream system transactions occurring across extended time periods, and to attribute downstream business outcomes such as completed appointments, closed sales, or fulfilled validation requirements back to the specific originating page request and parameter state that initiated the user journey.

As used herein, “white-label deployment” refers to a deployment architecture in which a shared landing page runtime infrastructure serves multiple distinct organizational clients, each of which presents landing page experiences that are outwardly branded, templated, and configured according to that client's specific requirements, while the underlying parameter interpretation, page composition, permission enforcement, session management, and downstream integration logic is implemented once in a common technical substrate rather than being separately implemented or separately deployed for each client. A white-label deployment is not achieved through the deployment of separate platform instances per client, through the maintenance of client-specific code branches, or through the duplication of page infrastructure across clients, but rather through the application of client-specific configuration records—comprising branding assets, template preferences, parameter vocabulary mappings, business rule overrides, and destination specifications—that are retrieved at runtime based on client identifiers present in request parameters or domain names and applied by the shared runtime service to customize its behavior for each client. The white-label architecture enables platform operators to onboard new clients through data configuration rather than code development, to apply core infrastructure improvements simultaneously across all clients, and to serve clients with materially different branding, business rules, and system integrations from a single shared codebase, thereby avoiding the unsustainable cost structure and technical divergence that result from maintaining separate platform instances at scale.

As used herein, “validation token” refers to a request parameter conveyed with a landing page request that dereferences, through a datastore lookup, to a validation record specifying the nature, current status, and gating conditions of a pending identity verification, consent confirmation, transaction approval, or other prerequisite requirement that must be satisfied before certain page modes or actions are accessible to the requesting user. A validation token is not a general-purpose authentication credential or a session continuity mechanism, but rather a purpose-specific reference to a discrete validation instance that was issued by the platform or by an integrated external system in connection with a specific business workflow, such as a purchase pending identity confirmation, an appointment requiring consent acknowledgment, or a communication opt-in requiring explicit affirmative action. The validation token enables the parameter interpretation engine to retrieve the associated validation record and determine the current validation state—pending, in progress, completed, failed, or expired—which in turn governs whether the landing page should render validation-collection controls, present post-validation action modes, suppress gated controls entirely, or display expiration notices. The use of a validation token as a landing page request parameter enables validation workflows to be embedded within the landing page experience without requiring redirection to separate verification applications, preserving session continuity and maintaining a unified interaction context throughout the validation and post-validation phases of the user journey.

As used herein, “capability-aware message construction” refers to the process by which the system formulates the content, format, and interactive elements of an outbound communication based on the specific protocol and feature set determined to be available for the intended recipient's device and carrier environment, such that the communication makes use of the richest capabilities that are technically supported while preserving the essential intent and functionality of the message when those capabilities are absent. Capability-aware message construction is not the selection of a single universal message format applied regardless of recipient environment, nor is it a binary choice between a rich format and a plain-text fallback, but rather a construction process that adapts the message to the specific capability profile returned by the channel eligibility assessment for the given communication instance. When a richer protocol such as RCS is available, capability-aware construction may produce a message incorporating branded visual elements, interactive buttons, structured card layouts, and rich media; when only a more constrained protocol such as SMS is available, the same construction process produces a message that conveys the same interaction intent through text-based instructions, URL links, numbered reply options, and simplified narrative content. The capability-aware construction approach ensures that the core purpose of the communication—whether informational, transactional, or interactive—is preserved across all protocol environments, and that neither the unavailability of enhanced protocols nor the presence of those protocols distorts the fundamental communication goal established by the originating page interaction and campaign context.

### Conceptual Architecture

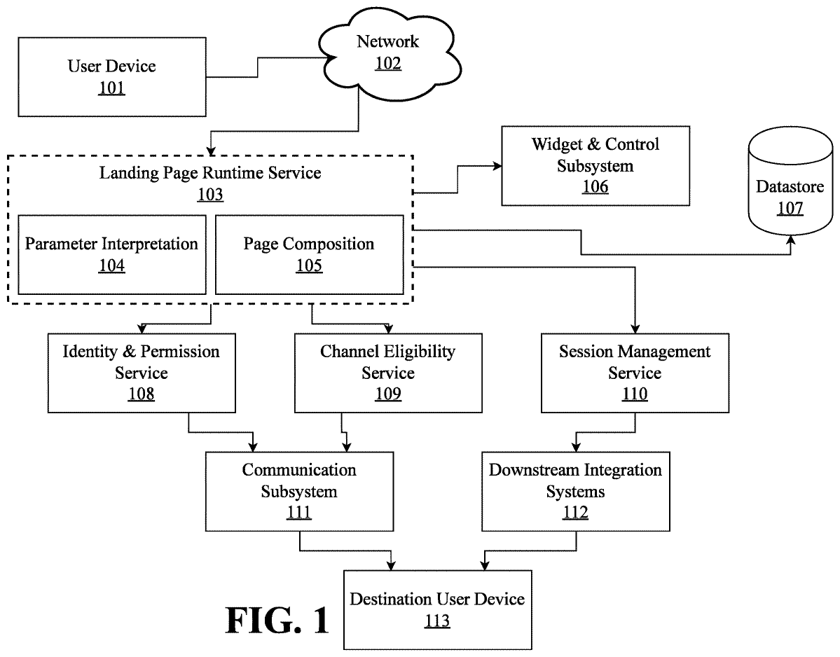

FIG. 1 is a system diagram illustrating an exemplary architecture for parameter-driven dynamic landing page communication orchestration according to a preferred embodiment.

A user device 101 represents a computing device operated by a user requesting access to a landing page. The user device 101 may comprise a smartphone, tablet, laptop computer, desktop computer, wearable device, kiosk terminal, or other computing device capable of requesting and rendering network-accessible content. The user device 101 communicates over a network 102, which may comprise the internet, a cellular network, a local area network, a wide area network, or any combination of wired or wireless communication infrastructure.

The network 102 connects the user device 101 to a landing page runtime service 103, which constitutes the core orchestration layer of the disclosed system. The landing page runtime service 103 receives page requests, interprets parameters, retrieves contextual data, determines runtime page behavior, and coordinates downstream interactions. Within the landing page runtime service 103 are two principal subsystems: a parameter interpretation component 104 and a page composition component 105. The parameter interpretation 104 subsystem processes request-associated values including campaign identifiers, product identifiers, validation tokens, client identifiers, user-associated identifiers, and other runtime parameters, resolving them into executable page states. The page composition 105 subsystem dynamically assembles the landing page by selecting templates, inserting content fragments, applying branding, and rendering controls based on the interpreted parameter state and retrieved contextual records.

A widget & control subsystem 106 is communicatively coupled to the landing page runtime service 103 and is responsible for instantiating, configuring, and binding executable page elements including buttons, forms, widgets, message initiators, and other interactive controls. The widget & control subsystem 106 enables dynamic insertion of controls whose appearance, behavior, and backend bindings are determined at runtime rather than being fixed in advance.

A datastore 107 is operatively connected to the landing page runtime service 103 and stores page templates, content fragments, campaign records, product associations, parameter maps, user-associated records, identity profiles, opt-in records, validation records, session records, flow rules, control definitions, widget configurations, branding assets, client-specific configuration records, and downstream routing rules. The datastore 107 may comprise one or more relational databases, document stores, key-value stores, or other persistent storage mechanisms.

An identity & permission service 108 is communicatively coupled to the landing page runtime service 103 and maintains persistent user identity profiles, phone-number-anchored records, opt-in states, consent records, permission levels, and authorization rules. The identity & permission service 108 determines whether page-triggered actions are permitted for a given user or context, enabling the system to enforce permission-gated and consent-aware interaction flows.

A channel eligibility service 109 is likewise coupled to the landing page runtime service 103 and evaluates available communication protocols and channels based on device capability, carrier support, message platform availability, user environment, and technical feasibility. The channel eligibility service 109 enables the system to select appropriate communication paths including SMS, MMS, RCS, email, web-based messaging, application-based messaging, or masked relay channels, and to determine whether richer or fallback protocols should be used.

A session management service 110 is operatively connected to the landing page runtime service 103 and assigns, maintains, and retrieves session identifiers linking together page entry, page interactions, communication launches, downstream routing events, and follow-on user responses. The session management service 110 preserves continuity across surfaces, protocols, and system boundaries, enabling a page-initiated interaction to remain coherent even when it transitions into messaging, agent engagement, or external system handoff.

A communication subsystem 111 receives page-triggered communication instructions from the landing page runtime service 103 and initiates or facilitates communications over one or more channels. The communication subsystem 111 may interface with messaging gateways, email delivery services, RCS platforms, web-based chat systems, application messaging services, or masked relay platforms to deliver communications launched from dynamically rendered page controls.

Downstream integration systems 112 represent one or more external or enterprise systems including customer relationship management systems, call centers, sales routing platforms, analytics systems, loyalty or rewards platforms, scheduling systems, validation services, external APIs, or other third-party destinations. Page-triggered interactions may be routed to downstream integration systems 112 with full session context, attribution data, and identity linkage preserved.

A destination user device 113 represents a computing device associated with a destination user who may receive communications initiated from the landing page or who may be the subject of downstream routing or transaction events. The destination user device 113 may comprise a mobile phone, smartphone, tablet, or other communication-capable device.

In operation, the architecture illustrated in FIG. 1 enables a unified parameter-driven orchestration workflow. When a user device 101 requests a landing page through the network 102, the request arrives at the landing page runtime service 103 carrying one or more runtime parameters embedded in the URL, query string, path, tokens, or headers. The parameter interpretation 104 component extracts and resolves these parameters by consulting the datastore 107 to retrieve associated campaign records, product contexts, validation states, or user-linked identities. Concurrently, the identity & permission service 108 is queried to determine what actions are authorized for the requesting user based on persistent identity records and opt-in states, while the channel eligibility service 109 assesses what communication protocols are technically feasible given the user's device capabilities and carrier environment. The page composition 105 component synthesizes this retrieved context into a runtime page state object that dictates which template to load, what content fragments to insert, what branding to apply, and crucially, which controls should be rendered and how those controls should be bound to backend actions. The widget & control subsystem 106 then instantiates the selected interactive elements, ensuring that a button rendered for one parameter state may initiate a communication flow while an analogous button rendered under different parameter conditions may instead trigger validation, scheduling, or downstream routing. Throughout this process, the session management service 110 assigns a session identifier that links the initial page request to all subsequent interactions, ensuring that when the user activates a control, the resulting action carries forward the full context established at page load.

When a user interaction occurs on the composed page, the landing page runtime service 103 processes the event by again consulting the identity & permission service 108 and channel eligibility service 109 to confirm that the requested action remains authorized and technically viable. If the user activates a communication control, the communication subsystem 111 constructs and delivers a message to the destination user device 113 using the most appropriate channel as determined by capability assessment, embedding the session identifier within message metadata to preserve continuity for any follow-on responses. If the user instead activates a control bound to a downstream business process, the landing page runtime service 103 routes the interaction to the relevant component within downstream integration systems 112, transmitting not only the immediate action request but also the full session context, campaign attribution, identity linkage, and provenance data retrieved from the datastore 107. In this manner, the architecture functions as a dynamic control plane wherein a single landing page endpoint can instantiate multiple distinct user journeys, launch communications across multiple protocols, route interactions to multiple downstream destinations, and preserve session continuity across page boundaries, messaging handoffs, and protocol fallbacks, all while maintaining a shared technical infrastructure that reduces page proliferation and enables white-label deployment for multiple clients with client-specific configurations stored in the datastore 107 and applied at runtime by the landing page runtime service 103.

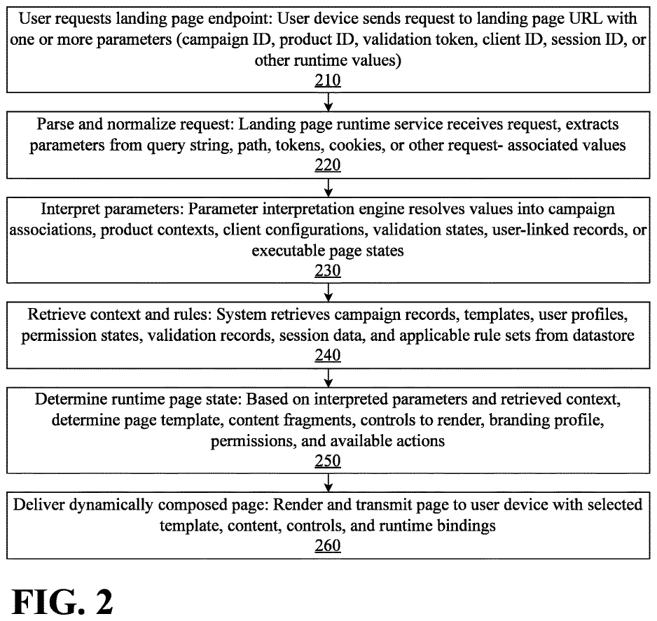

FIG. 2 is a method diagram illustrating the receipt and processing of a landing page request comprising one or more query-string parameters, path parameters, tokens, or other runtime request values according to a preferred embodiment. The method depicted in FIG. 2 demonstrates how the disclosed system transforms an inbound page request into a dynamically composed landing page whose behavior, content, and available actions are determined by interpreting the parameters accompanying that request and retrieving contextual records associated with those parameters.

The process begins at step 210, where a user requests a landing page endpoint. The user device sends a request to a landing page URL carrying one or more parameters that may include a campaign ID, product ID, validation token, client ID, session ID, or other runtime values. These parameters may be conveyed through various request mechanisms including query strings, path segments, URL fragments, cookies, HTTP headers, posted form data, signed tokens, or encrypted payloads. The parameters constitute the input data from which the system will determine the effective behavior of the requested page, transforming what would otherwise be a static destination into a programmable interaction surface.

At step 220, the landing page runtime service receives the request and initiates a parse and normalize operation. The service extracts parameters from the query string, path, tokens, cookies, or other request-associated values, and normalizes them into a canonical internal representation. This normalization may involve decoding URL-encoded values, validating signatures or encryption on token-based parameters, checking expiration times where applicable, and translating client-specific parameter vocabularies into a platform-standard schema. The output of this step is a structured runtime request object containing the parsed and validated parameter values ready for interpretation.

Step 230 performs parameter interpretation, wherein a parameter interpretation engine resolves the extracted values into meaningful runtime associations. A campaign ID is resolved to a campaign record; a product ID is resolved to a product context; a validation token is dereferenced to a validation state record; a client ID maps to a client-specific configuration; and user-linked identifiers reference persistent identity profiles or transaction-associated records. This resolution step transforms raw parameter strings into rich contextual objects that carry business logic, flow rules, permission states, and other executable information. The interpretation process may involve multiple datastore lookups, rule evaluations, and contextual enrichments, ultimately producing a set of resolved associations that define the logical intent and constraints of the requested page.

At step 240, the system performs a comprehensive retrieval of context and rules by querying the datastore for campaign records, page templates, user profiles, permission states, validation records, session data, and applicable rule sets associated with the resolved parameter associations. This retrieval operation gathers all the contextual intelligence needed to make informed decisions about page composition. For example, a campaign record may specify which template family to use, what messaging is appropriate, and what downstream destinations are valid; a user profile may indicate prior opt-in events, communication preferences, and interaction history; permission states determine which controls are authorized; and validation records may indicate whether certain actions require prerequisite confirmation steps. The retrieved data forms a comprehensive context envelope within which the page composition logic will operate.

Step 250 represents the critical determination phase where the system, based on interpreted parameters and retrieved context, determines the runtime page state. This determination encompasses selecting a page template appropriate to the campaign and product context, identifying content fragments to be inserted into that template, deciding which controls should be rendered and which should be suppressed, applying the correct branding profile for the client or campaign, enforcing permission and capability constraints on available actions, and binding rendered controls to their corresponding backend action handlers. The runtime page state object produced at this step is a complete specification of how the page should appear and behave for this particular request, reflecting the synthesis of parameter-driven intent, stored contextual data, and applicable business rules.

Finally, at step 260, the system delivers the dynamically composed page to the user device. The page is rendered according to the determined runtime state and transmitted with the selected template, inserted content, configured controls, applied branding, and runtime action bindings all in place. From the user's perspective, they receive a fully functional landing page tailored to their specific context, yet from the system's perspective, this page was assembled on demand from reusable components governed by parameter-driven logic rather than being retrieved as a pre-authored static artifact. This delivery step completes the transformation of a parameterized request into a context-aware, permission-gated, and action-capable interaction surface.

The method illustrated in FIG. 2 demonstrates the core technical mechanism by which the disclosed system enables a single landing page endpoint to support multiple distinct user experiences without requiring separate hard-coded pages for each scenario. By treating the request parameters as executable input rather than mere identifiers, and by synthesizing those parameters with retrieved contextual intelligence and rule-based logic, the system dynamically determines not only what content to display but what actions are permitted, what controls should be available, and how those controls should behave when activated. This parameter-driven approach materially reduces page proliferation, simplifies campaign management, enables white-label deployment across multiple clients, and allows page behavior to evolve through configuration changes rather than code redeployment.

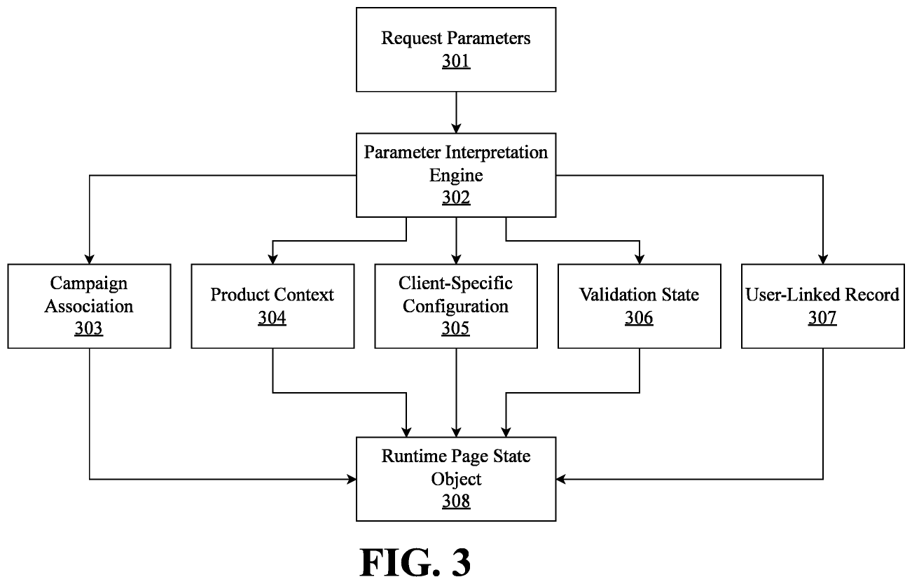

FIG. 3 is a block diagram illustrating the operation of a parameter interpretation engine configured to resolve one or more request parameters into one or more campaign associations, product associations, validation associations, client-specific configurations, or executable page states according to a preferred embodiment. The diagram depicts the transformation process by which raw parameter values are interpreted and enriched into structured contextual objects that collectively determine the runtime behavior of the dynamically composed landing page.

At the top of the diagram, request parameters 301 represent the input to the interpretation process. These parameters arrive with the landing page request and may include campaign identifiers, product identifiers, validation tokens, client identifiers, transaction-linked identifiers, user-associated identifiers, session identifiers, or other runtime values conveyed through query strings, path segments, tokens, cookies, or headers. The request parameters 301 serve as the raw material from which the system will derive the effective page state, but in their initial form they are merely strings or encoded values that require interpretation to unlock their semantic meaning.

The request parameters 301 are fed into a parameter interpretation engine 302, which constitutes the central processing component responsible for parsing, validating, mapping, and resolving parameter values into meaningful associations. The parameter interpretation engine 302 performs several key operations: it validates parameter format and signatures, checks for expiration on token-based parameters, normalizes values into canonical representations, translates client-specific parameter vocabularies into platform-standard schemas, dereferences indirect parameter references to retrieve underlying records, and maps parameter values to their corresponding contextual entities. The engine operates as a sophisticated resolver that transforms opaque identifiers into rich contextual objects by consulting datastores, applying mapping rules, and retrieving associated records.

The parameter interpretation engine 302 produces multiple distinct output streams representing different categories of resolved context. A campaign association 303 emerges when a campaign identifier parameter is successfully resolved to a campaign record containing flow rules, destination mappings, messaging guidelines, and other campaign-specific logic. The campaign association 303 provides the system with knowledge about which marketing or operational initiative is driving the current page request, enabling campaign-appropriate content selection and action bindings.

A product context 304 results from resolving a product identifier parameter to a product or service record containing descriptive information, applicable templates, associated workflows, and product-specific routing destinations. The product context 304 informs the system about what offering or subject matter the page concerns, allowing the page composition logic to select product-relevant content fragments, render product-specific controls, and route interactions to product-appropriate downstream systems.

A client-specific configuration 305 is retrieved when a client identifier parameter or host name indicates which white-label client is making the request. The client-specific configuration 305 contains branding assets, template preferences, custom parameter vocabularies, client-specific rule overrides, destination mappings unique to that client, legal disclaimers, and other client-scoped settings. This configuration enables the shared landing-page runtime to behave as if it were a bespoke system for each individual client while maintaining a common technical substrate underneath.

A validation state 306 is produced when the parameter interpretation engine 302 resolves a validation token or authorization parameter to a validation record indicating whether prerequisite conditions have been satisfied. The validation state 306 may indicate that a user has completed identity verification, accepted terms, confirmed a transaction, or satisfied other gating requirements, or conversely that validation remains pending or has expired. This state determination is critical because it governs whether certain page controls should be rendered in active or disabled states, whether communication actions should proceed directly or require additional approval, and whether the page should enter a validation-collection mode versus a post-validation action mode.

A user-linked record 307 emerges when a user-associated identifier, phone number, transaction-linked identifier, or other persistent reference is resolved to a user identity profile containing interaction history, opt-in states, communication preferences, prior session data, device associations, loyalty status, and other accumulated contextual intelligence about the specific individual making the request. The user-linked record 307 enables the system to personalize the page experience based on who the user is and what relationship they have with the platform, and more importantly, it allows the system to enforce permission and consent constraints tied to that user's specific authorization state.

All of these resolved outputs—campaign association 303, product context 304, client-specific configuration 305, validation state 306, and user-linked record 307—converge into a runtime page state object 308 at the bottom of the diagram. The runtime page state object 308 represents the synthesized result of the entire interpretation process, containing a complete specification of how the landing page should be composed and what actions should be available. This object includes the selected template identifier, the set of content fragments to insert, the branding profile to apply, the list of controls to render along with their configuration and bindings, the permission constraints governing each control, the channel eligibility determinations affecting communication actions, the session identifier linking this request to potential follow-on interactions, and the flow rules determining how user interactions should be processed. The runtime page state object 308 is the definitive source of truth for page composition and serves as the input to subsequent page rendering and control binding operations.

The process illustrated in FIG. 3 demonstrates how the disclosed system transforms simple parameter strings into rich executable context through a layered interpretation and resolution architecture. Rather than treating parameters as mere routing codes or cosmetic personalization triggers, the parameter interpretation engine 302 uses them as keys to unlock comprehensive contextual records spanning campaigns, products, clients, validation states, and user identities. This approach enables a single parameter set to simultaneously influence multiple dimensions of page behavior—what template is used, what content appears, what controls are shown, what actions are permitted, and what downstream destinations are engaged—without requiring the parameter values themselves to encode all of this complexity. The runtime page state object 308 produced by this process serves as a compact yet complete representation of the dynamically determined page experience, enabling the page composition layer to instantiate the correct interaction surface for each unique combination of request parameters and retrieved context.

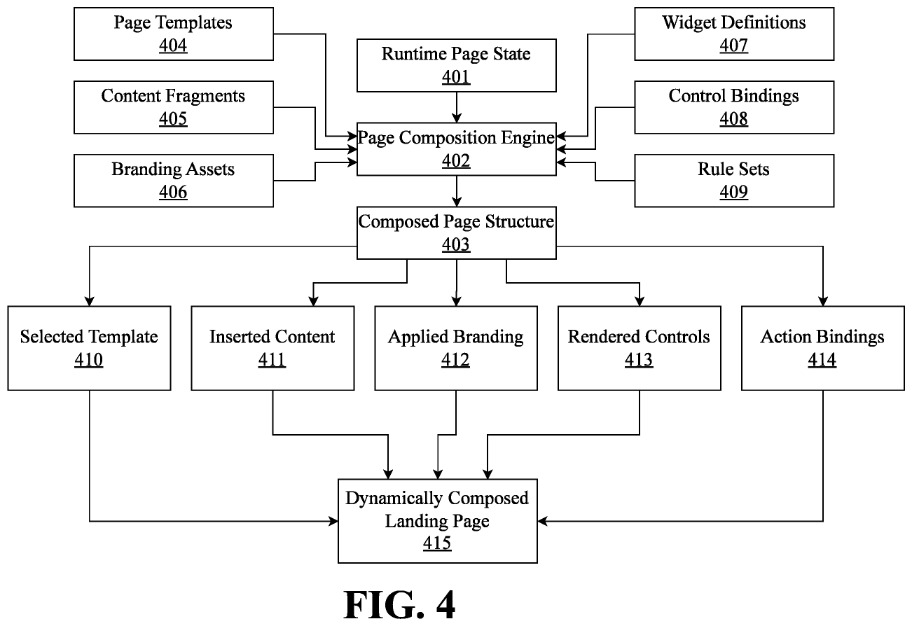

FIG. 4 is a block diagram illustrating dynamic page composition using one or more page templates, content fragments, widget definitions, control bindings, and runtime configuration records according to a preferred embodiment. The diagram depicts the process by which a runtime page state is transformed into a fully composed landing page through the systematic assembly of reusable components, applied branding, and dynamically bound controls.

At the top of the diagram, a runtime page state 401 serves as the input to the composition process. This runtime page state 401 is the output of the parameter interpretation and context retrieval operations described in prior figures, and it contains a complete specification of what page experience should be instantiated for the current request. The runtime page state 401 carries the resolved campaign association, product context, client configuration, validation state, user-linked record, permission constraints, and flow rules that collectively define the intended page behavior.

The runtime page state 401 is processed by a page composition engine 402, which constitutes the central orchestration component responsible for assembling the final page from constituent parts. The page composition engine 402 operates as a rule-driven assembly system that consults the runtime page state 401 to determine which components to retrieve, how to configure them, and how to bind them together into a coherent interaction surface. The engine coordinates multiple parallel retrieval and configuration operations, synthesizing diverse inputs into a unified page structure.

The page composition engine 402 draws upon several categories of stored resources to perform its assembly function. Page templates 404 provide the structural scaffolding and layout definitions for different page types or modes. A page template defines regions where content can be inserted, placeholder locations for widgets and controls, responsive behavior rules for different device classes, and the overall visual hierarchy of the page. The page composition engine 402 selects from among available page templates 404 based on the campaign type, product category, client preferences, or flow mode specified in the runtime page state 401.

Content fragments 405 comprise reusable blocks of text, headlines, descriptions, explanatory panels, instructions, disclaimers, product information, offer details, or other narrative content that can be inserted into template regions. The page composition engine 402 retrieves relevant content fragments 405 according to the campaign context, product context, user language preferences, and content relevance rules encoded in the runtime page state 401, ensuring that the assembled page presents information appropriate to the specific interaction scenario.

Branding assets 406 include logos, color schemes, typography specifications, client-specific terminology, legal text, support contact information, and other visual and textual elements that convey brand identity. The page composition engine 402 applies the correct branding assets 406 based on the client-specific configuration resolved during parameter interpretation, enabling white-label deployment wherein multiple clients share the same page composition infrastructure while presenting distinct branded experiences.

Widget definitions 407 specify the available types of interactive page elements including message launchers, callback request widgets, scheduling controls, validation prompts, loyalty redemption interfaces, form components, and other executable controls. Each widget definition 407 describes the widget's visual presentation, input requirements, state management logic, and interface contract with backend services. The page composition engine 402 consults widget definitions 407 to instantiate the specific control types called for by the runtime page state 401.

Control bindings 408 map rendered controls to their corresponding backend action handlers, communication services, validation workflows, or downstream routing destinations. A control binding 408 specifies what should happen when a user activates a particular button or widget, including which API endpoints to invoke, what parameters to pass, what permission checks to perform, and what session linkage to preserve. The page composition engine 402 uses control bindings 408 to ensure that dynamically inserted controls are not merely decorative but are operationally connected to the appropriate backend logic.

Rule sets 409 contain the conditional logic governing which components should be included or suppressed based on the current runtime page state 401. A rule set 409 may specify that a communication-launch control should only be rendered if permission state permits, that a validation widget should be shown only if validation status is pending, that certain content fragments should be suppressed for particular user segments, or that control appearance should adapt based on device capability. The page composition engine 402 evaluates applicable rule sets 409 to make dynamic inclusion and configuration decisions during the assembly process.

The page composition engine 402 produces a composed page structure 403 representing the intermediate assembled state before final rendering. This composed page structure 403 organizes all selected and configured components into their designated positions within the chosen template, creating a complete page specification ready for transmission to the user device.

The composed page structure 403 encompasses several distinct elements. A selected template 410 identifies which page template was chosen and instantiated based on the runtime page state 401. Inserted content 411 represents the specific content fragments that were retrieved and placed into template regions, providing the narrative and informational substance of the page. Applied branding 412 reflects the client-specific visual identity, terminology, and legal elements that were overlaid onto the page structure. Rendered controls 413 are the specific widgets and interactive elements that were instantiated based on widget definitions 407 and configured according to the runtime page state 401. Action bindings 414 represent the complete set of backend connections linking rendered controls 413 to their corresponding service endpoints, ensuring that user interactions will trigger the correct downstream operations.

All of these elements combine to form a dynamically composed landing page 415 at the bottom of the diagram. The dynamically composed landing page 415 is the final output of the composition process, ready for delivery to the user device. This page is not a static artifact retrieved from storage, but rather a runtime assembly constructed specifically for the current request by combining reusable components according to parameter-driven logic and context-aware rules. The dynamically composed landing page 415 contains not only the visual presentation but also the operational bindings that make the page a functional control surface capable of launching communications, triggering validations, initiating scheduling flows, or routing interactions to downstream systems.

The architecture illustrated in FIG. 4 demonstrates how the disclosed system achieves both flexibility and efficiency through component reuse and rule-driven assembly. Rather than maintaining separate hard-coded pages for each distinct interaction scenario, the system maintains libraries of reusable page templates 404, content fragments 405, branding assets 406, widget definitions 407, control bindings 408, and rule sets 409 that can be combined in numerous ways to produce diverse page experiences. The page composition engine 402 acts as the intelligent assembler that synthesizes these components according to the runtime page state 401, enabling a single technical substrate to support multiple campaigns, multiple clients, multiple products, and multiple user contexts without requiring separate page implementations for each combination. This compositional approach materially reduces development overhead, simplifies maintenance by centralizing component definitions, enables rapid deployment of new page experiences through configuration rather than coding, and supports white-label scenarios wherein client-specific branding and behavior can be applied to shared page structures. The resulting dynamically composed landing page 415 is simultaneously tailored to the specific request context and constructed from battle-tested reusable components, providing both customization and reliability.

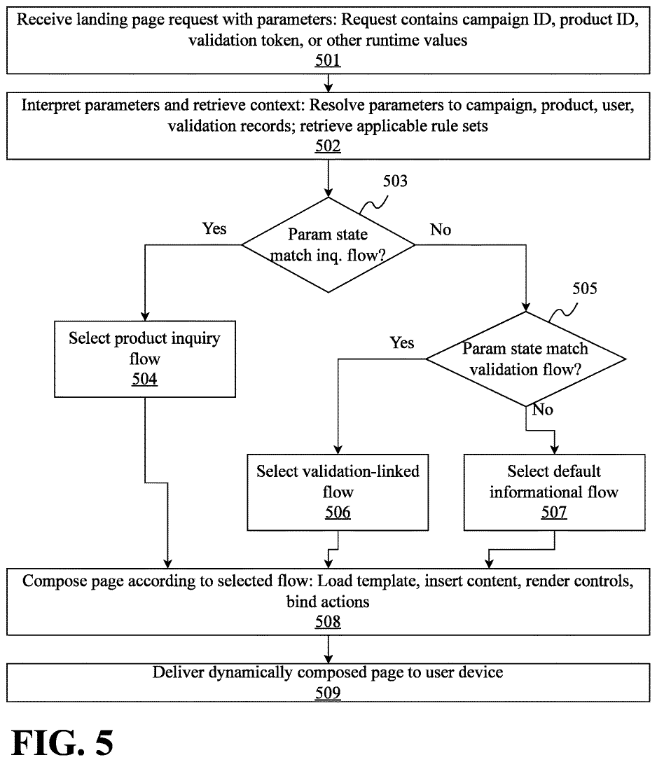

FIG. 5 is a method diagram illustrating page-load flow selection based on request parameters and one or more retrieved rule sets according to a preferred embodiment. The diagram depicts the decision-making process by which the system evaluates parameter state and contextual conditions to select among multiple distinct interaction flows, demonstrating how a single landing page endpoint can dynamically instantiate different user experiences based on runtime determinations rather than relying on separate static pages for each scenario.

The process begins at step 501, where the system receives a landing page request with parameters. The request contains a campaign ID, product ID, validation token, or other runtime values that have been embedded in the URL, query string, path, or request payload. These parameters serve as the input signals that will guide the flow selection logic, but at this initial stage they are merely raw values awaiting interpretation.

At step 502, the system performs parameter interpretation and context retrieval operations. The system resolves the received parameters to their corresponding campaign records, product records, user records, and validation records by consulting one or more datastores. Additionally, the system retrieves applicable rule sets that govern which flows are appropriate under various parameter and context combinations. This step enriches the raw parameter values with comprehensive contextual intelligence including campaign-specific flow preferences, product-specific routing logic, user-specific permission states, and validation-specific gating requirements. The output of this step is a fully resolved runtime context object containing not only the parameter associations but also the rules and constraints that will govern the subsequent flow selection decision.

The system then proceeds to decision step 503, which evaluates whether the parameter state matches the criteria for a product inquiry flow. This evaluation examines the resolved parameter associations and retrieved rule sets to determine whether the current request context corresponds to a user seeking product information, product comparison, product configuration assistance, or other product-centric interaction modes. The determination may depend on factors such as the presence and type of product identifier, the campaign context indicating a product-focused initiative, the absence of validation requirements, or explicit flow-selection hints embedded in the parameter set. If the parameter state matches the product inquiry flow criteria, the process branches along the “Yes” path.

Following the “Yes” branch from decision 503, the system arrives at step 504, where it selects the product inquiry flow. This selection determines that the landing page should be composed in a mode optimized for presenting product information, collecting product-related questions, enabling product-specific communication paths, or routing to product support or sales destinations. The product inquiry flow selection sets the stage for subsequent page composition operations to load product-appropriate templates, insert product-specific content, render product inquiry controls, and bind those controls to product-focused backend actions.

If the parameter state does not match the product inquiry flow criteria at decision 503, the process follows the “No” branch to decision step 505, which evaluates whether the parameter state matches the criteria for a validation-linked flow. This evaluation examines whether the request contains a validation token, whether that token resolves to a validation record requiring user action, whether the validation state indicates pending confirmation or expired authorization, or whether campaign rules mandate a validation step before other actions can proceed. The validation-linked flow is appropriate when the user must complete identity verification, accept terms and conditions, confirm a transaction, approve a communication opt-in, or satisfy other prerequisite requirements before accessing full page functionality.

If decision 505 determines that the parameter state matches validation-linked flow criteria, the process follows the “Yes” branch to step 506, where it selects the validation-linked flow. This selection indicates that the landing page should be composed in a mode that presents validation prompts, identity confirmation controls, consent collection interfaces, or approval request mechanisms. The validation-linked flow may render certain communication or transaction controls in a disabled or deferred state until validation completes, or may present only validation-related controls while suppressing other actions entirely. The flow selection at step 506 ensures that the composed page appropriately gates access to downstream actions based on validation state.

If the parameter state matches neither the product inquiry flow criteria at decision 503 nor the validation-linked flow criteria at decision 505, the process follows the “No” branch from decision 505 to step 507, where it selects a default informational flow. This default flow serves as the fallback when the parameter state does not clearly correspond to more specific flow types, when parameters are missing or malformed, when retrieved context is insufficient to determine a specialized flow, or when the request represents a general-purpose page access without a strongly defined interaction intent. The default informational flow typically presents general campaign or service information, provides basic contact or inquiry options, and offers navigation paths to more specialized flows without presuming a particular user goal.

After one of the three flow selection steps—product inquiry flow 504, validation-linked flow 506, or default informational flow 507—has been executed, all paths converge at step 508, where the system composes the page according to the selected flow. This composition operation loads the template appropriate to the selected flow, inserts content fragments relevant to that flow type, renders controls consistent with the flow's interaction model, and binds those controls to backend actions aligned with the flow's intended outcomes. The page composition at step 508 is informed not only by the flow selection itself but also by the full runtime context retrieved at step 502, ensuring that client-specific branding, user-specific permissions, campaign-specific messaging, and other contextual factors are applied in addition to the flow-specific structural decisions.

Finally, at step 509, the system delivers the dynamically composed page to the user device. The delivered page reflects the selected flow and appears to the user as a purpose-built landing page optimized for their specific context, yet it was assembled on demand from reusable components governed by the flow selection logic illustrated in this diagram.

The method depicted in FIG. 5 demonstrates a critical advantage of the disclosed parameter-driven architecture: a single landing page endpoint can support multiple logically distinct user journeys without requiring separate URLs or separate page implementations for each journey type. The flow selection decisions at steps 503 and 505 operate as runtime routing logic that directs the page composition process down different assembly paths while remaining within a unified technical framework. This approach enables rapid deployment of new flow types through the addition of new decision branches and corresponding composition rules, rather than requiring new page development. It also allows flow selection logic to evolve based on accumulated learning about which parameter patterns correspond to which user intents, without necessitating changes to the page endpoint itself. The branching structure illustrated in FIG. 5 is representative rather than exhaustive; real-world implementations may include additional decision points evaluating parameter state against criteria for scheduling flows, loyalty redemption flows, agent-request flows, callback flows, or other specialized interaction modes, all emanating from the same initial parameter interpretation step 502 and all converging into the same composition step 508 before delivery at step 509. This extensible decision architecture ensures that the system can accommodate growing interaction complexity while preserving the fundamental principle that parameter-driven interpretation, not URL proliferation, determines user experience.

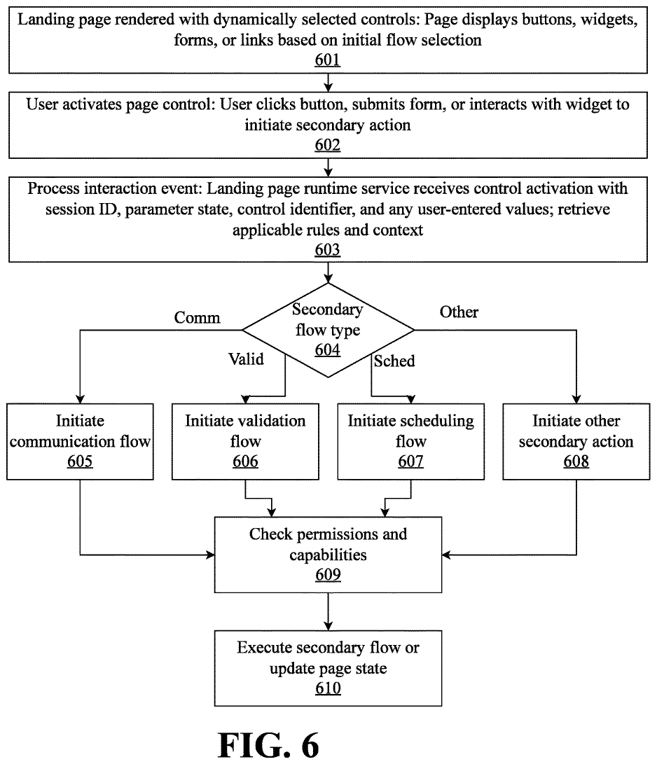

FIG. 6 is a method diagram illustrating the initiation of one or more secondary or subsequent flows through user interaction with one or more dynamically rendered page controls according to a preferred embodiment. The diagram demonstrates how the disclosed system continues to function as an active orchestration surface after initial page load, enabling users to trigger additional actions, branch into alternative workflows, or progress through multi-stage interaction sequences while preserving session continuity and enforcing runtime permission constraints.

The process begins at step 601, where the landing page has been rendered with dynamically selected controls. At this stage, the page displays buttons, widgets, forms, or links based on the initial flow selection that occurred during the page composition process described in prior figures. The controls visible to the user are not arbitrary or universally present; rather, they were specifically chosen and configured according to the runtime page state determined from request parameters, retrieved context, permission evaluations, and flow selection logic. Different users reaching the same endpoint under different parameter conditions may see materially different control sets at this stage, reflecting the parameter-driven nature of the system.

At step 602, a user activates a page control by clicking a button, submitting a form, or interacting with a widget to initiate a secondary action. This user interaction represents a transition from the initial page presentation mode into an active execution mode wherein the user's intent to perform a specific action must be interpreted, authorized, and routed. The control activation generates an interaction event that is transmitted from the user device back to the server-side runtime service, carrying information about which control was activated and any user-entered values associated with that activation.

Step 603 performs interaction event processing, wherein the landing page runtime service receives the control activation along with the session ID linking this interaction back to the original page request, the parameter state that was established at page load, the control identifier specifying which button or widget was activated, and any user-entered values such as form field contents, selected options, or text input. The runtime service retrieves applicable rules and context associated with the activated control, consulting datastores to obtain current permission states, validation requirements, channel eligibility determinations, and routing instructions. This retrieval operation ensures that the system makes authorization and routing decisions based on the most current state rather than relying solely on information that was accurate at page load time, accommodating scenarios where permission states or validation statuses may have changed during the user's interaction with the page.

The system then reaches decision point 604, which determines the secondary flow type appropriate for the activated control and current context. This determination examines the control identifier to understand what category of action the user intended, evaluates the retrieved rules and context to confirm what action is permitted and feasible, and classifies the resulting flow into one of several predefined categories. The decision point 604 routes execution down different paths based on whether the user interaction corresponds to a communication initiation, a validation requirement, a scheduling request, or another type of secondary action.

If the secondary flow type is determined to be communication-related, the process follows the “Comm” branch to step 605, where the system initiates a communication flow. This initiation prepares or launches a messaging interaction, callback request, agent contact, or other communication pathway. The communication flow may involve constructing a message artifact, selecting an appropriate communication channel based on capability assessments, attaching session and attribution context to the outbound communication, or routing the communication request to a messaging gateway or relay service.

If the secondary flow type corresponds to validation requirements, the process follows the “Valid” branch to step 606, where the system initiates a validation flow. This flow presents identity verification prompts, collects consent confirmations, requests approval for gated actions, or otherwise executes validation logic necessary before the user's intended action can proceed. The validation flow may update validation state records, collect additional user information, trigger external verification services, or transition the page into a post-validation mode once validation completes successfully.

If the secondary flow type relates to scheduling, the process follows the “Sched” branch to step 607, where the system initiates a scheduling flow. This flow may present calendar interfaces, available time slot selections, appointment booking controls, callback time preferences, or other temporal coordination mechanisms. The scheduling flow interfaces with scheduling systems, calendar services, or agent availability platforms to facilitate the temporal aspect of the user's request.

If the secondary flow type does not match communication, validation, or scheduling categories, the process follows the “Other” branch to step 608, where the system initiates another secondary action. This catch-all category encompasses loyalty redemption requests, offer code applications, lead form submissions, information requests, preference updates, account-related actions, or any other page-triggered operation not covered by the more specific flow types. The flexibility of this branch ensures that the system can accommodate diverse interaction types without requiring exhaustive enumeration of every possible action category in the decision logic.

After one of the flow initiation steps—communication 605, validation 606, scheduling 607, or other secondary action 608—has been executed, all paths converge at step 609, where the system checks permissions and capabilities. This critical verification step confirms that the action identified and initiated in the prior step is actually authorized for the current user and technically feasible in the current environment. The permission check consults the identity and permission service to verify that the user's opt-in state, consent scope, and authorization level permit the requested action. The capability check queries the channel eligibility service to confirm that the selected communication protocol is supported by the user's device and carrier, that downstream systems are available to receive routing requests, or that other technical prerequisites are satisfied. If permission or capability checks fail, the system may block the action, present an error message, offer alternative pathways, or update the page state to reflect the constraint. If checks pass, the action proceeds to execution.

Finally, at step 610, the system executes the secondary flow or updates the page state. If the action was fully authorized and technically feasible, execution may involve transmitting a communication to a destination device, creating a record in a downstream Customer Relationship Management (“CRM”) system, booking an appointment in a scheduling platform, updating a validation status, or invoking an external API. Alternatively, if the action requires multi-stage progression or if the current interaction represents an intermediate step in a longer workflow, the system may update the page state by rendering new controls, hiding completed steps, displaying status indicators, or otherwise modifying the page appearance to reflect the current position in the flow. The session record is updated to log the control activation, the action taken, the execution outcome, and any resulting state changes, preserving continuity for subsequent interactions whether they occur on the same page, through follow-on messaging, or via downstream system engagement.

The method illustrated in FIG. 6 demonstrates that the disclosed landing page system is not merely a destination for displaying information but rather a persistent control plane through which users can initiate and progress through multi-stage interaction sequences. The secondary flow initiation capability means that a single page load can serve as the launching point for diverse downstream operations spanning communication, validation, scheduling, and transactional domains, with the specific operations available and their runtime behavior governed by the same parameter-driven, context-aware, permission-gated logic that determined the initial page composition. This continuity of orchestration from page load through control activation to secondary flow execution enables complex user journeys to unfold from a single landing page endpoint without requiring the user to navigate through multiple separate pages or without forcing the system to maintain excessive numbers of specialized page implementations. The branching structure at decision point 604 is representative of a general pattern wherein different control types or control contexts route to different execution subsystems while sharing common permission checking 609 and state management 610 infrastructure, ensuring that regardless of which secondary flow is initiated, appropriate authorization and capability constraints are enforced and session continuity is preserved.

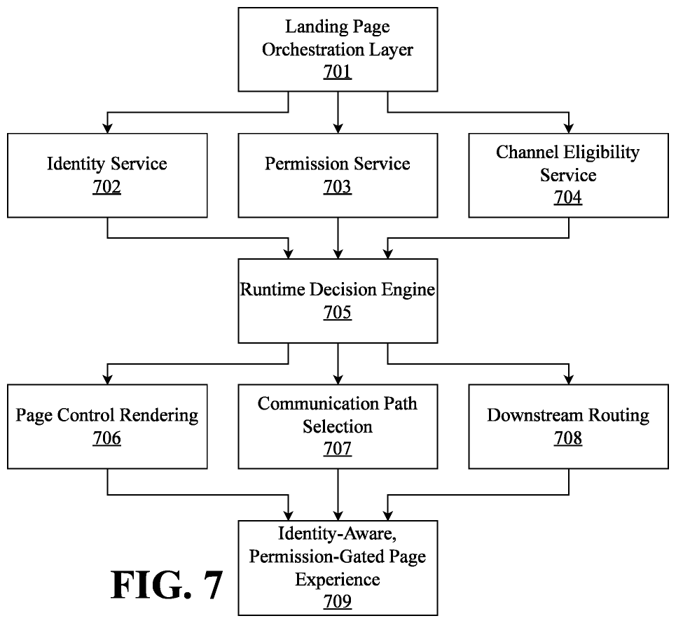

FIG. 7 is a system diagram illustrating the integration of the landing-page orchestration layer with one or more identity services, opt-in or permission services, and channel-eligibility services according to a preferred embodiment. The diagram depicts the architectural relationships and data flows among the orchestration layer and the supporting services that enable identity-aware, permission-gated, and capability-adapted page behavior, demonstrating how the disclosed system enforces authorization constraints and technical feasibility determinations throughout the page lifecycle.

At the top of the diagram, a landing page orchestration layer 701 represents the central coordination component responsible for receiving page requests, interpreting parameters, composing pages, processing user interactions, and initiating downstream actions. The landing page orchestration layer 701 encompasses the parameter interpretation, page composition, widget deployment, and control binding functions described in prior figures, and it serves as the primary decision-making authority that determines what page experience should be instantiated and what actions should be executed. However, the orchestration layer 701 does not operate in isolation; rather, it depends upon and integrates with multiple specialized services that provide the contextual intelligence necessary for making informed and compliant decisions about page behavior and action authorization.

The landing page orchestration layer 701 is communicatively coupled to an identity service 702, which maintains persistent user identity profiles and historical interaction records. The identity service 702 stores phone-number-anchored user records, email-linked profiles, transaction-associated identities, device associations, interaction histories, prior session records, loyalty status information, and other accumulated data about individual users across multiple touchpoints and over extended time periods. When the landing page orchestration layer 701 receives a request containing a user-associated identifier, validation token, phone number reference, or other identity-linked parameter, it queries the identity service 702 to retrieve the corresponding user profile. This retrieved profile informs the orchestration layer 701 about who the user is, what prior relationship exists between the user and the platform, what preferences or characteristics the user has expressed, and what historical context should influence the current page experience. The identity service 702 thereby enables the system to deliver personalized and contextually appropriate page experiences rather than generic one-size-fits-all presentations.

The landing page orchestration layer 701 is also coupled to a permission service 703, which manages opt-in states, consent records, authorization levels, and permission scopes for users and user classes. The permission service 703 maintains records indicating whether a given user has granted permission for various types of communication, whether consent applies to specific channels or topics, whether permission is time-limited or campaign-scoped, whether approval-gated or direct communication is authorized, and what restrictions or conditions apply to permitted actions. When the landing page orchestration layer 701 is determining what controls to render or evaluating whether a user-triggered action should be allowed to proceed, it queries the permission service 703 to obtain the current authorization state. The permission service 703 responds with determinations such as “communication permitted via SMS,” “communication requires approval gate,” “no communication authorized,” “validation required before action,” or other permission classifications that directly govern whether controls are rendered in active or disabled states, whether certain page modes are accessible, and whether downstream actions may execute. The permission service 703 thereby ensures that the landing page system respects user consent and regulatory requirements by enforcing permission constraints at both page composition time and action execution time.

Additionally, the landing page orchestration layer 701 is coupled to a channel eligibility service 704, which evaluates the technical feasibility and availability of various communication protocols and channels. The channel eligibility service 704 assesses factors including device type and capability, carrier support for advanced messaging protocols, application environment characteristics, browser capabilities, user location affecting regulatory compliance, message platform availability, protocol version support, and historical delivery success rates. When the landing page orchestration layer 701 is preparing to initiate a communication or determining what communication controls to offer, it queries the channel eligibility service 704 to determine what channels are technically viable. The channel eligibility service 704 responds with determinations such as “RCS supported,” “SMS only,” “email preferred,” “web-based messaging available,” or “no direct channel available, use relay,” enabling the orchestration layer 701 to select appropriate communication pathways and to render controls that reflect actual technical capabilities rather than presenting options that would fail upon execution. The channel eligibility service 704 thereby prevents user frustration and system errors by ensuring that offered communication methods are technically feasible for the current user and device environment.

The landing page orchestration layer 701 synthesizes inputs from the identity service 702, permission service 703, and channel eligibility service 704 through a runtime decision engine 705. The runtime decision engine 705 is a logical subsystem within the orchestration layer 701 that receives the user identity profile from the identity service 702, the permission state from the permission service 703, and the channel eligibility assessment from the channel eligibility service 704, and combines these inputs with the interpreted request parameters and retrieved campaign context to make comprehensive determinations about page behavior and available actions. The runtime decision engine 705 applies rule-based logic that considers multiple dimensions simultaneously: “this user is recognized and has prior interaction history (identity), this user has granted SMS permission but not email permission (permission), this user's device supports RCS (capability), therefore render an RCS message-launch control bound to this campaign's primary communication flow.” The runtime decision engine 705 thus functions as the integration point where identity awareness, permission enforcement, and capability adaptation converge into executable page decisions.

The output of the runtime decision engine 705 flows into three parallel execution paths representing different categories of orchestration outcomes. Page control rendering 706 represents the determination and instantiation of which interactive elements should appear on the page. The runtime decision engine 705 dictates that certain buttons, widgets, forms, or links should be rendered based on the synthesized understanding of who the user is, what they are permitted to do, and what technical capabilities exist. Controls may be rendered in active states, disabled states, approval-required states, or may be suppressed entirely based on these determinations. The page control rendering 706 ensures that the user sees only controls that are both contextually appropriate and operationally viable, preventing the presentation of actions that would be denied or fail upon activation.

Communication path selection 707 represents the determination of which communication channel, protocol, and routing mode should be used when the user activates a communication-triggering control. The runtime decision engine 705 selects among SMS, MMS, RCS, email, web-based messaging, application messaging, masked relay, or other available channels based on the channel eligibility assessment from the channel eligibility service 704, the permission constraints from the permission service 703, and the campaign preferences retrieved during parameter interpretation. The communication path selection 707 may further determine whether messages should include rich media, interactive elements, or plain text based on capability determinations, and whether communications should be direct or approval-gated based on permission state. This selection ensures that when a communication is actually initiated, it proceeds via a pathway that is both authorized and technically sound.

Downstream routing 708 represents the determination of which external or enterprise systems should receive page-triggered interaction events and what context should accompany those events. The runtime decision engine 705 determines whether a lead should be routed to a CRM system, whether an agent request should be queued in a call center platform, whether a scheduling request should be transmitted to a calendar service, whether a validation event should trigger an identity verification system, or whether a transaction should invoke an external API. The downstream routing 708 decision incorporates identity context from the identity service 702 to enrich routed events with user profile data, permission context from the permission service 703 to ensure routed interactions comply with authorization constraints, and session linkage to preserve continuity between the page interaction and downstream system engagement.

All three execution paths—page control rendering 706, communication path selection 707, and downstream routing 708—contribute to the final outcome at the bottom of the diagram: an identity-aware, permission-gated page experience 709. This represents the complete landing page interaction as experienced by the user, encompassing not only the visual presentation of the page but also the runtime behavior of its controls, the pathways through which communications flow, and the destinations to which interactions are routed. The identity-aware, permission-gated page experience 709 reflects the successful integration of identity intelligence, permission enforcement, and capability adaptation with parameter-driven page orchestration, resulting in a landing page that simultaneously respects who the user is, honors what the user has consented to, adapts to what the user's environment supports, and delivers the interaction flows called for by the campaign and product context encoded in the request parameters.

The architecture illustrated in FIG. 7 demonstrates a critical design principle of the disclosed system: the landing page orchestration layer 701 does not unilaterally determine page behavior based solely on request parameters, but instead operates as an integrating coordinator that consults specialized services providing identity, permission, and capability intelligence. This separation of concerns enables the identity service 702 to maintain comprehensive user profiles across the entire platform ecosystem rather than being limited to landing page interactions, allows the permission service 703 to enforce consistent consent and authorization rules across all platform touchpoints rather than implementing separate permission logic for each interaction surface, and permits the channel eligibility service 704 to accumulate technical capability intelligence from actual delivery attempts and device interactions across the platform rather than relying on static capability assumptions. The runtime decision engine 705 functions as the synthesis point where these diverse inputs are combined into coherent page-level decisions, ensuring that parameter-driven page orchestration operates within the boundaries established by identity recognition, permission constraints, and technical feasibility. This integrated architecture materially improves upon conventional landing page systems that treat authorization and capability as afterthoughts addressed through error handling rather than as foundational determinants of page composition and control availability, and it enables the disclosed system to provide user experiences that are simultaneously personalized through identity awareness, compliant through permission enforcement, and reliable through capability adaptation.

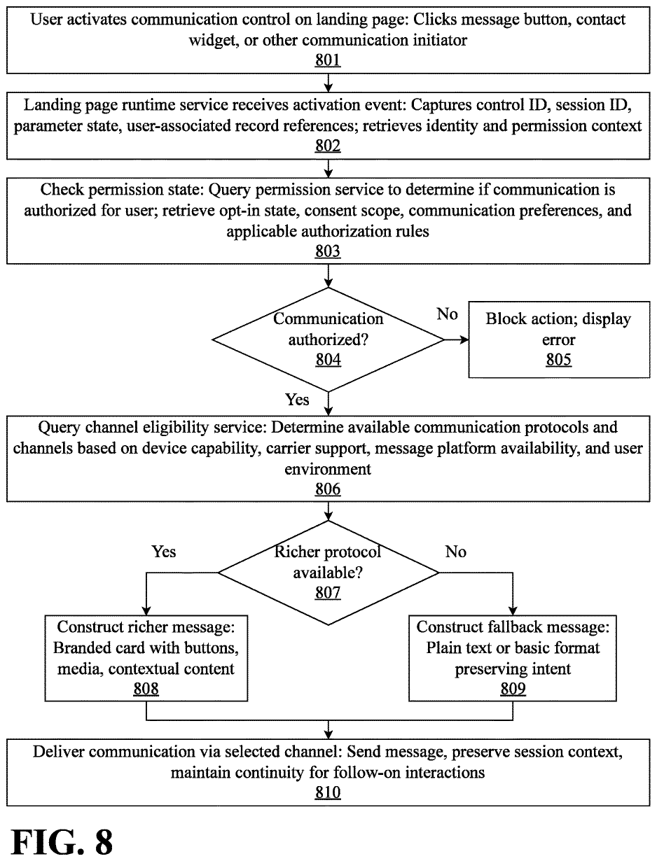

FIG. 8 is a sequence diagram illustrating capability-aware communication initiation from a dynamically rendered page control according to a preferred embodiment. The diagram depicts the end-to-end process by which a user's activation of a communication control triggers a series of authorization checks, capability assessments, and message construction decisions that culminate in the delivery of an appropriately formatted communication via a technically feasible and permission-compliant channel.

The sequence begins at step 801, where a user activates a communication control on the landing page by clicking a message button, contact widget, or other communication initiator. This control was dynamically rendered during the page composition process based on the runtime page state, but its presence on the page does not guarantee that communication is actually authorized or technically feasible; rather, the control's activation triggers a comprehensive evaluation sequence that determines whether and how the communication should proceed. The user's click generates an interaction event that is transmitted from the client device to the server-side landing page runtime service along with metadata identifying the activated control and the session context.

At step 802, the landing page runtime service receives the activation event and initiates processing by capturing the control ID identifying which specific button or widget was activated, the session ID linking this interaction to the original page request and any prior interactions, the parameter state that was established during initial request interpretation, and references to user-associated records that were resolved during page composition. The runtime service retrieves identity and permission context by querying datastores and services to obtain the current state of the user's profile, opt-in status, and authorization scope. This retrieval ensures that authorization decisions are based on current state rather than potentially stale information from page load time, accommodating scenarios where permission states may have changed during the user's interaction with the page or where time-limited consent may have expired.

Step 803 performs a permission state check by querying the permission service to determine if communication is authorized for the current user. The runtime service retrieves the user's opt-in state indicating whether the user has granted any form of communication permission, the consent scope specifying what types of communication or topics are covered by that permission, communication preferences indicating preferred channels or frequency limits, and applicable authorization rules that may impose additional conditions such as time-of-day restrictions, campaign-specific consent requirements, or regulatory compliance constraints. The permission service evaluates these factors and returns a determination indicating whether communication is permitted unconditionally, permitted subject to approval or validation gates, or prohibited entirely.

The process reaches decision point 804, which evaluates whether communication is authorized based on the permission determination returned at step 803. This decision point enforces permission constraints by blocking unauthorized communications before any technical capability assessment or message construction occurs, ensuring that the system respects user consent and regulatory requirements regardless of technical feasibility. If the permission check indicates that communication is not authorized, the process follows the “No” branch.

Following the “No” branch from decision 804, the process arrives at step 805, where the system blocks the action and displays an error message. The runtime service prevents the communication from proceeding and may update the page state to inform the user that communication is not currently permitted, potentially explaining the permission constraint or offering an alternative action such as requesting consent or updating communication preferences. The process terminates at this point without initiating any outbound communication, preserving compliance with the user's authorization state.

If decision 804 determines that communication is authorized, the process follows the “Yes” branch to step 806, where the system queries the channel eligibility service to determine available communication protocols and channels. This query provides information about the user's device type and capability, carrier support for advanced messaging protocols such as RCS, message platform availability indicating which delivery systems are operational, user environment characteristics such as application installation or browser capabilities, and any technical constraints or preferences retrieved from prior delivery attempts. The channel eligibility service evaluates these factors and returns an assessment indicating which communication channels are technically viable, including information about whether richer protocols with interactive or multimedia capabilities are supported or whether only basic text-based protocols are available.

The process reaches decision point 807, which evaluates whether a richer protocol is available based on the channel eligibility assessment from step 806. This decision determines whether the communication can be delivered using an enhanced channel such as RCS with branded cards, buttons, and media, or whether a fallback to a simpler format such as plain SMS or basic email is necessary. The determination considers not only whether the device theoretically supports richer protocols but also whether the carrier infrastructure, message platform, and current network conditions make richer delivery practically achievable. If a richer protocol is available and reliable, the process follows the “Yes” branch.

Following the “Yes” branch from decision 807, the process arrives at step 808, where the system constructs a richer message using the enhanced capabilities of the selected protocol. The message construction incorporates branded visual elements such as logos and color schemes, interactive components such as buttons enabling in-message responses or actions, multimedia content such as images or video, structured content layout with cards and sections, and contextual information tailored to the specific campaign, product, or user context. The richer message preserves the full intent and functionality of the communication while taking advantage of the enhanced presentation and interaction capabilities available through the richer protocol. The message construction embeds session context, attribution data, and callback mechanisms enabling the platform to maintain continuity if the user responds or activates in-message controls.

If decision 807 determines that a richer protocol is not available, the process follows the “No” branch to step 809, where the system constructs a fallback message using plain text or basic formatting that preserves the intent and essential information of the communication while adapting to the constraints of the available channel. The fallback message may contain text-only content, URLs as text rather than embedded buttons, simplified instructions for user response, and any essential context presented in a linear narrative format rather than structured visual layout. Despite the reduced presentation capabilities, the fallback message construction ensures that the core communication purpose—whether informational, transactional, or interactive—can still be accomplished within the limitations of the available protocol. The fallback construction maintains session linkage and attribution context so that continuity is preserved even when the communication format is simplified.

After either the richer message construction at step 808 or the fallback message construction at step 809, the process converges at step 810, where the system delivers the communication via the selected channel. The delivery operation transmits the message through the appropriate messaging gateway, email delivery service, RCS platform, or other channel-specific infrastructure, embedding session context within message metadata or headers to enable correlation of subsequent user responses with the originating page interaction. The system preserves session context by maintaining a mapping between the delivered message identifier and the session record established during the initial page request, ensuring that if the user replies to the message or clicks links within the message, those follow-on interactions can be attributed back to the landing page session and processed with full awareness of the original request parameters, campaign context, and user profile. The delivery maintains continuity for follow-on interactions by storing sufficient state information to resume the conversation or transaction flow regardless of whether the user's next action occurs via message reply, page revisit, or downstream system engagement.

The sequence illustrated in FIG. 8 demonstrates a sophisticated multi-stage decision process that occurs between the moment a user clicks a communication control and the actual delivery of a message to that user's device. Unlike conventional landing page systems that might simply construct and send a message immediately upon control activation, the disclosed system enforces a layered evaluation framework ensuring that communications are both authorized and appropriately formatted for the recipient's technical environment. The permission check at steps 803 and 804 ensures compliance with consent and regulatory requirements by blocking unauthorized communications before any resources are expended on message construction or delivery attempts. The capability assessment at steps 806 and 807 enables intelligent adaptation to device and carrier constraints, selecting richer protocols when available to provide enhanced user experiences while gracefully degrading to simpler formats when necessary to ensure reliable delivery. The separate message construction paths at steps 808 and 809 demonstrate that the system does not treat capability limitations as error conditions requiring generic fallback behavior, but instead applies thoughtful construction logic that preserves communication intent and functionality within whatever format constraints exist. The session context preservation at step 810 ensures that the communication is not treated as an isolated message but rather as a continuation of the page interaction, enabling subsequent responses to be processed with full awareness of the originating campaign, product context, and user profile. This integrated approach to communication initiation materializes the principle that a landing page in the disclosed system is not merely a web destination that happens to include a messaging button, but rather a comprehensive communication orchestration platform that evaluates authorization, assesses capabilities, adapts message formats, and preserves interaction continuity across channel boundaries.

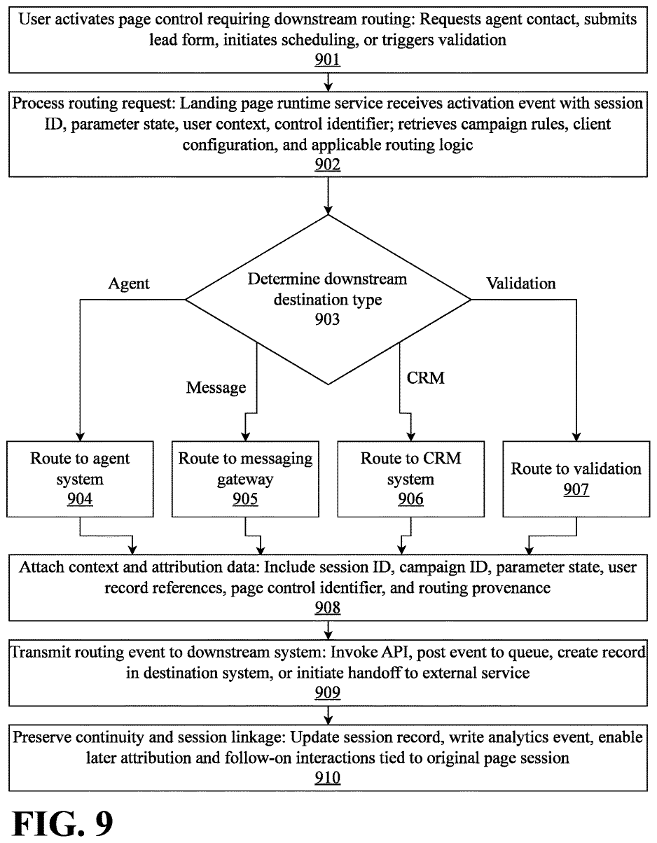

FIG. 9 is a method diagram illustrating page-triggered routing to one or more downstream destinations including agent systems, messaging services, customer relationship management systems, or validation services according to a preferred embodiment. The diagram depicts the comprehensive routing workflow by which user interactions with landing page controls are translated into structured events or records delivered to external or enterprise systems while preserving full session context, attribution data, and interaction provenance.

The process begins at step 901, where a user activates a page control requiring downstream routing by requesting agent contact, submitting a lead form, initiating scheduling, or triggering validation. These control activations represent user intents that cannot be fully satisfied within the landing page itself but instead require engagement with external business systems or service platforms. The activated control may be a “Request Callback” button routing to an agent platform, a “Submit Inquiry” form routing to a CRM system, a “Schedule Appointment” widget routing to a calendar service, or a “Verify Identity” control routing to a validation platform. The user's interaction generates an activation event that is transmitted to the server-side runtime service carrying information about which control was activated and what user-entered data accompanied the activation.

At step 902, the landing page runtime service processes the routing request by receiving the activation event along with the session ID linking this interaction to the original page request and all prior page interactions, the parameter state that was established during initial request interpretation and that defines the campaign, product, and client context, the user context including identity profile and permission state, and the control identifier specifying which specific button, form, or widget was activated. The runtime service retrieves campaign rules that may dictate preferred routing destinations or routing priorities for different interaction types, client configuration that specifies client-specific destination mappings or integration endpoints, and applicable routing logic that determines how different control types or user contexts should map to downstream systems. This retrieval ensures that routing decisions are informed not only by the immediate control activation but also by the broader campaign strategy, client preferences, and business rules governing system integrations.

The process reaches decision point 903, which determines the downstream destination type appropriate for the activated control and current context. This determination examines the control identifier to understand what category of downstream system is needed, evaluates campaign and client rules to identify the preferred or required destination for this interaction type, considers user context to apply any user-specific or permission-specific routing logic, and classifies the routing target into one of several destination categories. The decision point 903 routes execution down different paths based on whether the interaction should be directed to an agent system for human handling, a messaging gateway for communication delivery, a CRM system for lead or contact management, or a validation service for identity verification or approval workflows.

If the destination type is determined to be an agent system, the process follows the “Agent” branch to step 904, where the system routes to an agent system. This routing operation transmits the interaction event to a call center platform, agent queue management system, customer service platform, or sales routing system where human representatives can process the user's request. The routing to an agent system may involve creating a task record, enqueueing a callback request, initiating a live chat session, or generating an assignment for a specific agent or agent team based on campaign rules, product specialization, geographic routing, or availability constraints.

If the destination type is a messaging gateway, the process follows the “Message” branch to step 905, where the system routes to a messaging gateway. This routing directs the interaction to a messaging platform responsible for delivering outbound communications, managing message queues, handling protocol-specific delivery, or facilitating two-way messaging interactions. The routing to a messaging gateway may be appropriate when the user has activated a control requesting information delivery, opted into a messaging campaign, or initiated a conversation that should proceed via messaging channels rather than through the landing page interface.

If the destination type is a CRM system, the process follows the “CRM” branch to step 906, where the system routes to a CRM system. This routing transmits the interaction event to a customer relationship management platform where it becomes a lead record, contact record, opportunity, case, or other CRM entity. The routing to a CRM system captures the user's interest, inquiry, or intent within the client's business process systems, enabling follow-up workflows, sales processes, marketing automation, or customer success operations to proceed based on the landing page interaction. The CRM routing may include enrichment with user profile data, campaign attribution, product context, and any form data collected through the landing page control.

If the destination type is a validation service, the process follows the “Validation” branch to step 907, where the system routes to validation. This routing transmits the interaction to an identity verification service, approval workflow system, fraud detection platform, or authorization gateway that must evaluate, confirm, or approve some aspect of the user's request before further action can proceed. The routing to a validation service may be triggered when the user activates a control requiring identity confirmation, when campaign rules mandate verification before certain actions are permitted, or when client requirements impose gating conditions on downstream processing.

After one of the routing steps—agent system 904, messaging gateway 905, CRM system 906, or validation 907—has been executed, all paths converge at step 908, where the system attaches context and attribution data to the routing event. This critical enrichment step ensures that downstream systems receive not merely a bare notification that an interaction occurred, but comprehensive contextual information enabling those systems to understand the origin, purpose, and circumstances of the interaction. The attached data includes the session ID linking the routing event back to the original landing page request and enabling correlation with any prior or subsequent interactions within the same session, the campaign ID identifying which marketing or operational initiative drove the user to the landing page and triggered the downstream interaction, the parameter state containing all resolved campaign associations, product contexts, client configurations, and user-linked records that shaped the page experience, user record references providing identity information and profile data to downstream systems subject to appropriate permission and privacy constraints, the page control identifier specifying which button, form, or widget was activated to enable analytics about which page elements drive downstream engagement, and routing provenance data documenting the decision path and rule evaluations that led to the selection of this particular downstream destination. This comprehensive context attachment transforms what might otherwise be a generic lead or event into a richly attributed interaction carrying full awareness of its landing page origins.

At step 909, the system transmits the routing event to the downstream system using the appropriate integration mechanism. The transmission may involve invoking an API endpoint exposed by the downstream system and sending a structured payload containing the interaction data and attached context, posting an event to a message queue or event stream that the downstream system consumes asynchronously, creating a record directly in the destination system's database through a database integration or connector, or initiating a handoff to an external service through webhooks, scheduled data transfers, or other integration patterns. The transmission method is determined by the technical capabilities and integration requirements of the specific downstream system, with the landing page runtime service adapting its transmission approach to match whatever integration pattern the destination supports. The transmitted event or record carries all context and attribution data attached at step 908, ensuring that downstream systems receive complete information regardless of transmission mechanism.

Finally, at step 910, the system preserves continuity and session linkage by updating the session record to log the routing event, writing analytics events documenting the control activation and downstream routing for reporting and attribution purposes, and enabling later attribution and follow-on interactions tied to the original page session. The session record update captures information about when the routing occurred, what destination was selected, what context was transmitted, and what outcome resulted from the routing attempt, creating a durable audit trail linking the landing page interaction to downstream system engagement. The analytics event writing enables reporting systems to attribute downstream outcomes such as closed sales, completed appointments, or successful validations back to the specific landing page, campaign, parameter set, and control activation that initiated the downstream flow. The continuity preservation ensures that if the user later returns to the landing page, responds to a message, or interacts with a downstream system, those subsequent interactions can be recognized as continuations of the same user journey rather than being treated as unrelated events. This comprehensive session linkage enables the platform to maintain coherent interaction histories spanning landing page visits, downstream system engagement, messaging interactions, and protocol transitions, supporting sophisticated attribution models and enabling consistent user experiences across multiple touchpoints.

The method illustrated in FIG. 9 demonstrates that downstream routing in the disclosed system is not a simple redirect or link-following operation but rather a sophisticated data integration process that preserves rich contextual information and maintains session continuity across system boundaries. The decision point 903 and its multiple routing branches reflect the reality that landing pages in modern business environments must integrate with diverse downstream systems serving different business functions, and that a single landing page endpoint may need to route different user interactions to different destinations based on control type, user intent, campaign rules, and client configuration. The context attachment at step 908 addresses a critical limitation of conventional landing page systems wherein downstream systems often receive only minimal information about the origin of an interaction—perhaps just a form submission or a referral URL—without the comprehensive campaign attribution, user profile enrichment, and session linkage that enable downstream systems to process interactions intelligently and maintain continuity with the landing page experience. The transmission flexibility at step 909 acknowledges that different downstream systems support different integration patterns and that a practical landing page orchestration platform must adapt to diverse technical environments rather than imposing a single rigid integration model. The continuity preservation at step 910 ensures that the routing event is not treated as the terminal point of the landing page interaction but rather as one event within an ongoing session that may include additional page interactions, follow-on communications, or downstream system responses, all linked through persistent session identifiers and contextual records. This comprehensive approach to downstream routing enables the disclosed landing page system to function as a true integration hub that not only presents information and collects user input but actively orchestrates the flow of interactions and context across multiple business systems while preserving attribution, maintaining continuity, and enabling sophisticated multi-system workflows to be initiated from dynamically composed page controls.

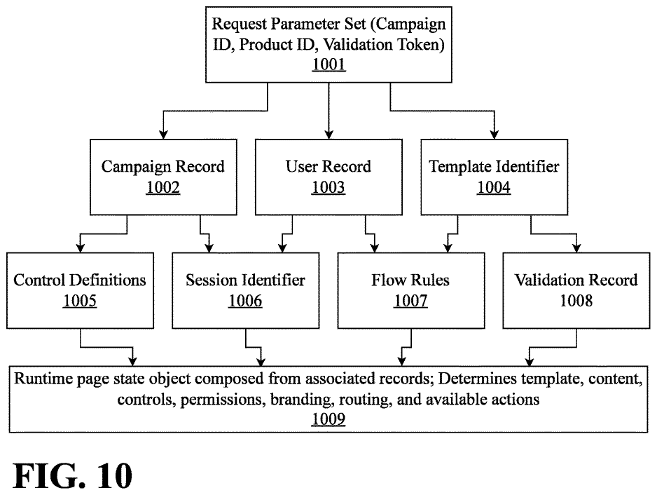

FIG. 10 is a data structure diagram illustrating associations among request parameters, campaign records, user-associated records, template identifiers, control definitions, session identifiers, and flow rules according to a preferred embodiment. The diagram depicts the relational architecture by which discrete data entities stored in various datastore tables or collections are retrieved, associated, and synthesized into a unified runtime page state object that governs all aspects of dynamic landing page composition and behavior.

At the top of the diagram, a request parameter set 1001 represents the collection of parameter values received with a landing page request. This parameter set contains identifiers such as campaign ID, product ID, and validation token that arrive embedded in the URL query string, path segments, or request payload. The request parameter set 1001 constitutes the initial input to the system's interpretation and resolution logic, but at this stage the parameters are merely opaque strings or encoded values that require dereferencing to unlock their semantic meaning and associated contextual data. The request parameter set 1001 serves as the key material through which the system will navigate datastores to retrieve the richer records and associations necessary for determining runtime page behavior.

The request parameter set 1001 is connected via association arrows to multiple data record types that are retrieved based on parameter values. A campaign record 1002 is retrieved when the campaign ID parameter is resolved through a datastore lookup. The campaign record 1002 contains comprehensive information about the marketing or operational campaign including campaign name, objective, target audience, applicable flow rules governing how users should be engaged within this campaign, messaging guidelines specifying what content and tone are appropriate, destination mappings indicating where leads or interactions should be routed, conversion goals defining what outcomes the campaign seeks to achieve, and temporal constraints such as campaign start and end dates. The campaign record 1002 provides the system with strategic context about why the user is being engaged and what interaction patterns are appropriate within this campaign framework.

A user record 1003 is retrieved when a user-associated identifier, phone number, transaction-linked identifier, or validation token parameter resolves to a persistent user identity profile. The user record 1003 contains accumulated data about the specific individual including phone number or other stable identifiers anchoring the identity, opt-in state indicating what communication permissions have been granted, interaction history documenting prior engagements with the platform across multiple touchpoints, device associations linking the user to specific devices or channels, loyalty status or rewards program participation, preference settings for communication frequency or content types, and prior session records enabling recognition of returning users. The user record 1003 enables the system to personalize the page experience based on who the user is and to enforce permission constraints tied to that user's specific authorization state.

A template identifier 1004 is determined through evaluation of the campaign record 1002, product context, client configuration, and flow selection logic. The template identifier 1004 references a page template definition stored in the datastore, and that template definition specifies the structural layout including regions for content insertion, placeholder positions for widgets and controls, responsive design rules for different device form factors, visual hierarchy and organization patterns, and the overall framework within which dynamic content and controls will be composed. The template identifier 1004 effectively selects the canvas upon which the remainder of the page composition process will operate, determining the basic structure before content, branding, and controls are layered into that structure.

Control definitions 1005 are retrieved based on the flow rules associated with the campaign record 1002, the permission state associated with the user record 1003, and the page mode determined through flow selection logic. The control definitions 1005 specify what types of interactive elements are appropriate for the current page context, including widget type specifications describing available button types, form types, message launchers, or other control categories, configuration parameters defining how each widget type can be customized, action binding templates establishing how controls connect to backend services, label and terminology options allowing client-specific or campaign-specific control text, and rendering rules governing when controls should be shown, hidden, disabled, or restricted. The control definitions 1005 provide the vocabulary of interactive elements from which the page composition engine selects when determining what controls to render for the current runtime state.

A session identifier 1006 is created or retrieved to link the current page request to a persistent session record. The session identifier 1006 may be a newly generated UUID for a new session or may be an existing identifier retrieved from a cookie, query parameter, or prior interaction record when resuming a session. The session identifier 1006 connects to a session record containing the session UUID serving as the stable identifier across multiple interactions, timestamp information documenting when the session began and when it was last active, continuity link data associating the session with any prior or parallel sessions involving the same user or campaign, interaction log entries recording what pages were viewed and what controls were activated within the session, and state variables capturing the current position within multi-stage workflows. The session identifier 1006 enables the system to maintain continuity across page loads, messaging handoffs, and downstream system interactions by providing a stable reference point linking all related events.

Flow rules 1007 are retrieved from the campaign record 1002, client configuration, product associations, or platform-level rule sets. The flow rules 1007 encode the conditional logic and business rules governing page behavior including conditions that must be satisfied for different page modes or control types to be accessible, actions that should be triggered when certain conditions are met or when specific controls are activated, priority order specifications indicating which rules should be evaluated first when multiple rules apply, permission-gating logic determining what authorization checks must pass before actions execute, and routing logic specifying how interactions should be directed to downstream systems. The flow rules 1007 constitute the executable business logic that transforms static data records into dynamic behavioral decisions, enabling the system to adapt page composition and action processing based on runtime conditions.

A validation record 1008 is retrieved when a validation token parameter is resolved through datastore lookup. The validation record 1008 contains state information about pending, completed, or expired validation requirements including the token value that serves as the unique identifier for this validation instance, expiration timestamp indicating when the validation opportunity expires, status indicator showing whether validation is pending, succeeded, failed, or expired, associated user reference linking the validation to a specific user identity, required validation steps specifying what confirmation actions must be completed, and validation outcome data recording what information was collected or confirmed during validation. The validation record 1008 enables the system to gate access to certain page modes or actions based on whether prerequisite validation has been completed, and to present validation-specific controls or messaging when validation status indicates that user action is required.

All of these retrieved and associated records—campaign record 1002, user record 1003, template identifier 1004, control definitions 1005, session identifier 1006, flow rules 1007, and validation record 1008—converge at the bottom of the diagram into a runtime page state object 1009. The runtime page state object 1009 represents the synthesized result of all parameter interpretation, record retrieval, and rule evaluation operations, containing a complete specification of how the landing page should be composed and what actions should be available. This object is composed from the associated records retrieved through parameter resolution, meaning it is not a simple aggregation of those records but rather a processed synthesis that extracts relevant elements from each record, applies flow rules to determine what is appropriate and permitted, resolves any conflicts or precedence relationships among different data sources, and produces a unified specification ready for consumption by the page composition engine.

The runtime page state object 1009 determines multiple dimensions of page behavior. It specifies which template should be loaded based on the template identifier 1004 and any template selection rules. It identifies what content fragments should be inserted into template regions based on campaign messaging from the campaign record 1002, product context, and user-specific personalization from the user record 1003. It dictates which controls should be rendered based on the control definitions 1005 filtered through flow rules 1007 and permission states from the user record 1003. It establishes what permissions govern each control's availability and behavior based on opt-in state and authorization levels in the user record 1003. It applies what branding assets, color schemes, terminology, and visual identity elements should be used based on client-specific configuration. It defines what routing destinations should be engaged when controls are activated based on destination mappings in the campaign record 1002 and routing logic in flow rules 1007. It specifies what available actions the user may perform, what gating conditions apply to those actions, and what backend service endpoints should be invoked when actions are triggered. The runtime page state object 1009 thereby serves as the definitive source of truth for all page composition and action processing decisions, encapsulating the complete understanding of who the user is, what campaign context applies, what interactions are permitted, what technical capabilities exist, and what business objectives should be pursued.

The data structure relationships illustrated in FIG. 10 demonstrate that the disclosed system implements a sophisticated data architecture wherein simple parameter strings serve as entry points into a rich graph of associated records and rules. Rather than encoding all necessary context directly into parameter values—which would result in unwieldy URLs and would couple page behavior to parameter structure—the system uses parameters as lookup keys to retrieve comprehensive contextual records from persistent datastores. The multiple arrows flowing from the request parameter set 1001 to various record types reflect the reality that a single parameter may trigger retrieval of multiple associated records: a campaign ID retrieves a campaign record 1002 which in turn references flow rules 1007; a validation token retrieves a validation record 1008 which references a user record 1003; a product ID may reference both template preferences and content associations. This web of associations enables the system to navigate from minimal parameter input to comprehensive contextual understanding through datastore traversal. The convergence of all retrieved records into the runtime page state object 1009 reflects the architectural principle that page composition should operate from a unified state representation rather than consulting multiple disparate data sources during rendering, ensuring consistency and enabling efficient composition. The runtime page state object 1009 essentially serves as a materialized view of all relevant context for the current page request, precomputed and assembled by the parameter interpretation and context retrieval layers so that downstream page composition and action processing can operate against a single coherent data structure. This separation between parameter interpretation and context retrieval on one hand, and page composition and action execution on the other, enables independent evolution of the data model and composition logic, supports caching of resolved state for performance optimization, and provides clear architectural boundaries that simplify testing and debugging. The data structure architecture illustrated in FIG. 10 is fundamental to enabling the disclosed system's ability to support diverse page experiences from a common technical substrate, as it allows new campaigns, products, clients, or flow types to be introduced through data configuration in the form of new campaign records, control definitions, or flow rules, rather than requiring new code development or separate page implementations.

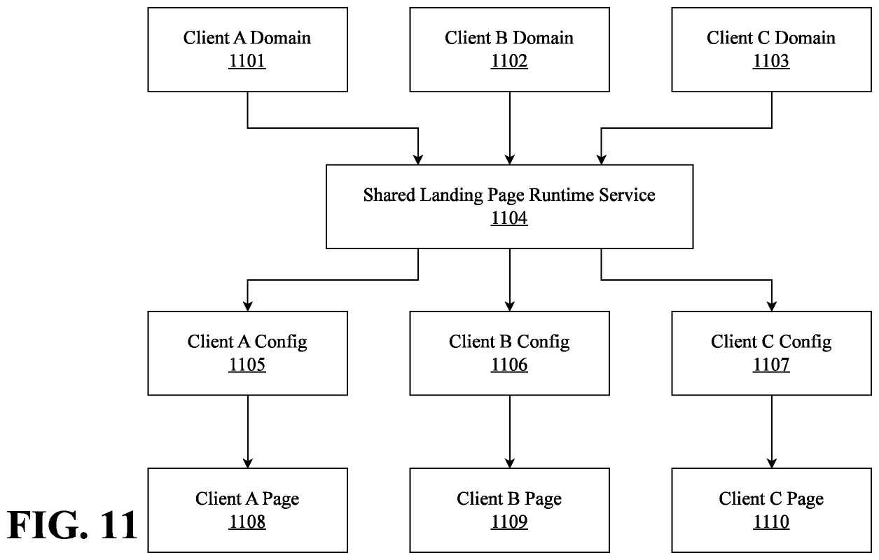

FIG. 11 is a system diagram illustrating a white-label deployment architecture in which multiple clients use a shared landing-page runtime with client-specific branding, templates, and rule sets according to a preferred embodiment. The diagram depicts how a common technical infrastructure can simultaneously serve multiple distinct clients while delivering outwardly different and client-customized experiences, demonstrating the disclosed system's ability to support multi-tenant scenarios without requiring separate platform instances or duplicated codebases for each client.

At the top of the diagram, three separate client domains are illustrated representing different organizational clients using the platform. Client A domain 1101 represents a first client's web presence, which may be hosted at a domain such as clienta.com or pages.clienta.com, providing a client-branded URL endpoint for users to access landing pages associated with that client's campaigns and services. Client B domain 1102 represents a second client with a distinct domain such as clientb.com, reflecting a separate organizational identity and brand. Client C domain 1103 represents a third client with yet another distinct domain such as clientc.com. Each client domain 1101, 1102, 1103 serves as the outward-facing entry point through which users access landing pages, and from the user's perspective, each domain appears to be an independent web property specific to that client's brand and business operations.

Despite the distinct outward appearances represented by the separate client domains 1101, 1102, 1103, all three domains route requests to a shared landing page runtime service 1104 that constitutes the common technical substrate underlying all client experiences. The shared landing page runtime service 1104 implements the core orchestration logic described throughout this disclosure, including common parameter interpretation logic that resolves request parameters into runtime associations regardless of which client's domain the request arrived from, page composition logic that dynamically assembles pages from templates and content fragments according to resolved runtime state, widget framework that instantiates and binds interactive controls to backend services, permission logic that enforces opt-in and authorization constraints across all clients using consistent permission evaluation rules, and session management that maintains interaction continuity using shared session identifier schemes and continuity tracking mechanisms. By implementing these core functions once in a shared service 1104 rather than duplicating them for each client, the platform operator achieves significant operational efficiency, ensures consistent behavior across all clients, simplifies maintenance by centralizing bug fixes and feature enhancements, and enables cross-client improvements and optimizations to benefit all clients simultaneously.

The shared landing page runtime service 1104 consults client-specific configurations to customize its behavior for each client while maintaining common underlying logic. Client A config 1105 contains configuration data specific to the first client, including brand A assets such as logos, color schemes, typography specifications, and visual identity elements that should be applied to pages served through client A domain 1101, template set A identifying which page templates are preferred or required for client A's campaigns and should be selected when composing pages for that client, rule set A encoding client-specific business rules such as preferred routing destinations, approval requirements, communication protocols, or interaction flow preferences that differ from other clients or from platform defaults, and destinations A specifying the downstream systems, CRM instances, agent platforms, messaging gateways, or external APIs that should receive interactions routed from client A's landing pages. The client A config 1105 enables the shared runtime service 1104 to behave as if it were a bespoke system built exclusively for client A when processing requests arriving from client A domain 1101.

Client B config 1106 contains analogous configuration data for the second client, including brand B assets providing a completely different visual identity from client A, template set B that may overlap partially with client A's templates where interaction patterns are similar but may include client-specific templates for unique client B workflows, rule set B encoding business rules that reflect client B's operational preferences which may differ significantly from client A's rules in areas such as permission enforcement strictness, validation requirements, or routing logic, and destinations B pointing to client B's specific downstream systems which are entirely separate from client A's systems. The client B config 1106 ensures that despite using the same shared runtime service 1104, client B receives an experience tailored to their brand identity and integrated with their specific business systems.

Client C config 1107 similarly contains brand C assets, template set C, rule set C, and destinations C, providing yet another distinct configuration layer enabling the shared runtime service 1104 to serve client C with appropriate customization. The existence of three separate client configurations 1105, 1106, 1107 demonstrates the platform's ability to support numerous clients simultaneously, with each configuration providing the customization parameters necessary to make the shared runtime service 1104 behave appropriately for that client's specific requirements.

The shared landing page runtime service 1104, operating according to the client-specific configurations, produces distinct page outputs for each client. Client A page 1108 represents the landing page experience delivered to users accessing the platform through client A domain 1101. This page exhibits brand A look through application of visual assets from client A config 1105, implements client A flows through selection of templates and rule execution from template set A and rule set A, and routes interactions to A destinations as specified in the client A config 1105. From the user's perspective, client A page 1108 appears to be a native property of client A, seamlessly integrated with client A's brand identity and business operations, with no visible indication that the underlying platform is shared with other clients.

Client B page 1109 represents the landing page experience delivered through client B domain 1102, exhibiting brand B look that is visually distinct from client A page 1108 despite being generated by the same shared runtime service 1104. The client B page 1109 implements client B flows that may involve different templates, different control types, different interaction sequences, or different permission gates compared to client A's flows, and routes interactions to B destinations that are entirely separate systems from those used by client A. The client B page 1109 maintains the illusion of being a client B-specific platform while actually being a runtime customization of the shared service 1104.

Client C page 1110 similarly represents the third client's distinct landing page experience, with brand C look, client C flows, and routing to C destinations, all generated from the same shared landing page runtime service 1104 but customized according to client C config 1107. The ability to produce three distinct page experiences 1108, 1109, 1110 from a single runtime service 1104 demonstrates the core value proposition of the white-label architecture: clients receive fully customized experiences appropriate to their brand identity and business requirements, while the platform operator maintains only one technical implementation rather than deploying separate systems for each client.

The architecture illustrated in FIG. 11 demonstrates several critical advantages of the disclosed white-label approach. First, the shared landing page runtime service 1104 eliminates duplicated engineering effort that would be required if each client needed a separately implemented landing page system, enabling the platform operator to serve multiple clients without linear scaling of development and maintenance costs. Second, the configuration-based customization through client configs 1105, 1106, 1107 enables rapid client onboarding, as adding a new client requires creating a new configuration record with appropriate branding assets, template selections, rules, and destination mappings rather than developing new code or deploying new infrastructure. Third, improvements and enhancements to the shared runtime service 1104 automatically benefit all clients simultaneously, ensuring that when new capabilities such as additional communication protocols, enhanced permission models, or improved analytics are added to the platform, all clients gain access to those capabilities without requiring client-specific development work. Fourth, the white-label architecture prevents technical divergence among client implementations, as all clients remain on the same version of the core platform logic, simplifying upgrades and ensuring consistent behavior across the client base. Fifth, the configuration-based approach enables flexible business models wherein different clients may subscribe to different feature sets or capability levels implemented through variations in their configuration records rather than through deployment of different code versions.

The white-label architecture also addresses practical operational challenges in multi-client environments. By maintaining client A config 1105, client B config 1106, and client C config 1107 as data records in a configuration datastore rather than as hard-coded values in application code, the platform operator can update client configurations without code deployment, enabling rapid adjustments to client branding, routing destinations, or flow rules in response to client requests or changing business conditions. The separation between client-facing domains 1101, 1102, 1103 and the shared backend service 1104 allows each client to maintain their own domain-level branding, SSL certificates, and DNS management while delegating the complex landing page orchestration logic to the platform, providing clients with domain control and brand ownership without burdening them with platform implementation responsibilities. The distinct page outputs 1108, 1109, 1110 ensure that despite the shared backend, each client's users experience pages that are fully consistent with that client's brand identity and that integrate seamlessly with that client's downstream business systems, preserving the perception of a purpose-built solution while delivering the efficiency benefits of a shared platform.

The white-label deployment model illustrated in FIG. 11 is particularly advantageous in scenarios where multiple clients within a vertical market or industry sector have similar functional requirements for landing page orchestration but require distinct brand presentations and system integrations. Rather than each client implementing their own landing page infrastructure or subscribing to generic one-size-fits-all solutions that cannot accommodate client-specific requirements, the disclosed architecture provides a middle path wherein common orchestration logic is shared for efficiency while client-specific customization is achieved through configuration, enabling both platform economies of scale and client-specific customization. This architecture is essential to the commercial viability of offering sophisticated landing page orchestration capabilities to multiple clients, as it avoids the unsustainable cost structure that would result from maintaining separate platform instances while simultaneously avoiding the inflexibility that would result from forcing all clients to accept identical page behaviors and integrations.

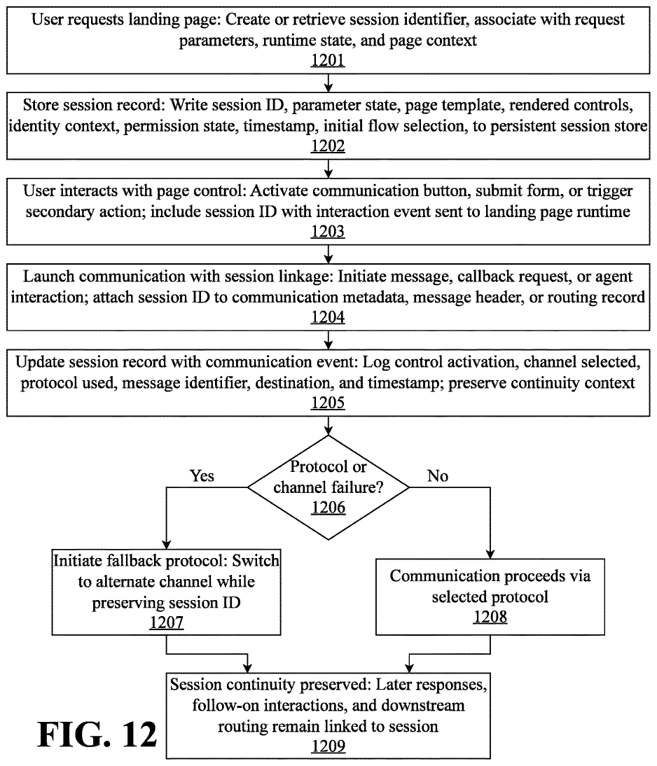

FIG. 12 is a method diagram illustrating preservation of session continuity across landing-page interaction, messaging handoff, and protocol fallback according to a preferred embodiment. The diagram depicts the comprehensive session management workflow by which a persistent session identifier is created, maintained, and propagated through multiple interaction stages and across system boundaries, enabling the platform to maintain coherent interaction histories and attribute downstream outcomes to originating page sessions even when communications traverse multiple channels or encounter technical failures requiring protocol adaptation.

The process begins at step 1201, where a user requests a landing page, triggering the system to create or retrieve a session identifier. If this is the user's first interaction with the platform or first access to this particular landing page endpoint within a defined session timeout period, the system generates a new session identifier, typically implemented as a Universally Unique Identifier (“UUID”) or other globally unique value that will serve as the stable reference linking all subsequent interactions within this user journey. If the user is resuming a prior session, indicated by the presence of a session cookie, a session parameter in the URL, or a stored session reference in local storage, the system retrieves the existing session identifier to maintain continuity with the prior interaction. The system associates the session identifier with the request parameters that arrived with the page request, the runtime state that was resolved through parameter interpretation and context retrieval, and the page context including campaign association, product context, client configuration, user identity, and permission state. This association creates a comprehensive session record that captures not only the fact that a session exists but also the complete contextual understanding of what campaign, product, user, and configuration drove this particular page experience.

At step 1202, the system stores the session record by writing comprehensive session state to a persistent session store. The stored record includes the session ID serving as the primary key for subsequent lookups, the parameter state containing all resolved campaign associations, product contexts, validation states, and user-linked records, the page template that was selected during composition indicating what structural framework was used for this page experience, the rendered controls documenting which buttons, widgets, forms, or links were actually presented to the user enabling later analysis of which controls were available when the user took action, the identity context linking the session to a user profile if identity was resolved during parameter interpretation, the permission state capturing what authorization levels and opt-in states applied at session creation time, the timestamp recording when the session began, and the initial flow selection documenting whether the page was composed in product inquiry mode, validation mode, default informational mode, or another flow category. This comprehensive session record serves as the authoritative source of truth about the page experience that was delivered and the context in which subsequent interactions should be interpreted.

At step 1203, the user interacts with a page control by activating a communication button, submitting a form, or triggering a secondary action. This interaction generates an event that is transmitted from the client device to the landing page runtime service, and critically, that event includes the session ID as part of the transmitted payload, header, or associated metadata. The inclusion of the session ID enables the runtime service to correlate this control activation with the original page request processed at step 1201 and to retrieve the full session context stored at step 1202, ensuring that the system processes the interaction with complete awareness of what page was shown, what campaign drove the interaction, who the user is, and what permissions apply. The session ID effectively bridges the gap between the initial page load and subsequent user actions, transforming what might otherwise be treated as isolated events into a coherent interaction sequence.

Step 1204 involves launching a communication with session linkage when the user's control activation at step 1203 triggers a communication flow. The system initiates a message, callback request, or agent interaction according to the control's configured action binding, and attaches the session ID to the communication through multiple potential mechanisms depending on the communication channel and protocol being used. For messaging channels such as SMS, MMS, or RCS, the session ID may be embedded in message metadata fields, custom headers, or tracking parameters that accompany the message through the delivery infrastructure without being visible to the end user. For agent interactions or callback requests, the session ID may be included in the routing record or task assignment transmitted to the agent platform, enabling agents to reference the original landing page context when engaging with the user. For web-based messaging or application messaging, the session ID may be stored in conversation metadata or thread identifiers. Regardless of the specific mechanism, the session linkage ensures that when communications are delivered, when users respond to those communications, or when agents process communication requests, all parties and systems have access to the session ID enabling retrieval of the complete landing page context from the session store.

At step 1205, the system updates the session record with the communication event by logging the control activation that triggered the communication, the channel selected for communication delivery such as SMS, RCS, email, or web messaging, the protocol used including version and capability details, the message identifier assigned by the messaging platform enabling correlation of delivery status and user responses with the session, the destination such as the phone number, email address, or user identifier to which the communication was sent, and the timestamp recording when the communication was initiated. This logging transforms the session record from a static snapshot of page state into a dynamic interaction history documenting not only what page was shown but what actions the user took and what communications resulted. The preservation of continuity context ensures that the session record maintains sufficient information to resume or continue the interaction if the user returns to the landing page, responds to the message, or engages through an alternative channel.

The process reaches decision point 1206, which evaluates whether a protocol or channel failure has occurred. This determination assesses whether the communication initiated at step 1204 failed to deliver successfully, whether the selected protocol proved to be unsupported despite channel eligibility predictions, whether network conditions prevented delivery, whether the messaging platform returned an error status, or whether delivery timeouts were exceeded. Protocol or channel failures can occur for numerous reasons including user device limitations not captured in capability assessments, carrier-level blocking or filtering, message platform outages, network connectivity issues, or message content triggering spam filters. The decision point 1206 determines whether the communication should be retried through a fallback protocol or whether the original protocol succeeded and should continue.

If decision point 1206 determines that a protocol or channel failure has occurred, the process follows the “Yes” branch to step 1207, where the system initiates a fallback protocol by switching to an alternate channel while preserving the session ID. The fallback operation selects a simpler or more reliable protocol based on a fallback hierarchy such as attempting RCS first, then falling back to MMS, then to SMS as a last resort for messaging channels, or attempting branded email first, then plain text email, then web-based notification. Critically, the fallback operation maintains the same session ID that was established at step 1201 and attached to the original communication attempt at step 1204, ensuring that despite the protocol change, the session continuity remains intact. The system updates the session record to log the fallback event, the original protocol that failed, the fallback protocol selected, and any relevant error information, creating an audit trail of the technical adaptations that occurred while maintaining the conceptual unity of the session.

If decision point 1206 determines that no protocol or channel failure has occurred, the process follows the “No” branch to step 1208, where the communication proceeds via the selected protocol without requiring fallback adaptation. The communication is successfully delivered through the original channel selection, and the session linkage established at step 1204 remains active and available for correlating subsequent user responses or follow-on interactions with the originating landing page session.

Both the fallback path through step 1207 and the successful delivery path through step 1208 converge at step 1209, where session continuity is preserved such that later responses, follow-on interactions, and downstream routing remain linked to the session. This preservation operates across multiple dimensions and time scales. When the user responds to the delivered communication by replying to a message, clicking a link embedded in the communication, or calling back through a provided contact mechanism, the platform uses the session ID to retrieve the complete landing page context from the session store, enabling the response to be processed with full awareness of what campaign drove the original page request, what product or service was the subject of inquiry, what user profile and permission state applied, and what prior interactions occurred within the session. When follow-on interactions occur such as the user returning to the landing page through a bookmark or navigating to related pages within a multi-page campaign flow, the session ID enables the platform to maintain continuity by recognizing the user's return and providing a consistent experience informed by prior actions. When downstream routing events occur such as a lead being synced to a CRM system, an agent picking up a callback request, or a scheduled appointment being confirmed, the session ID accompanies those routing events enabling downstream systems to reference back to the original landing page interaction and enabling the platform to attribute downstream outcomes such as closed sales or completed appointments to the specific page request, parameter set, and control activation that initiated the interaction sequence.

The method illustrated in FIG. 12 demonstrates that session continuity in the disclosed system is not a simple cookie-based page tracking mechanism but rather a comprehensive interaction correlation framework that maintains semantic relationships among page requests, user actions, communications, protocol transitions, and downstream outcomes across extended time periods and across multiple technical surfaces. The session identifier created at step 1201 functions as a thread that weaves through every subsequent interaction, and the session record stored at step 1202 and continuously updated at steps 1205 and implicitly at step 1207 serves as an ever-growing interaction history rather than a static page state snapshot. The session linkage established at step 1204 and preserved through the fallback handling at step 1207 ensures that the session identifier successfully crosses boundaries that often break continuity in conventional systems, such as the boundary between web page and messaging channel, the boundary between initial protocol and fallback protocol, and the boundary between immediate interaction and delayed response. The comprehensive continuity preservation at step 1209 enables sophisticated attribution models wherein downstream business outcomes occurring days or weeks after the initial page request can still be accurately attributed to that originating session, supporting analytics use cases such as calculating campaign ROI, determining which page controls drive the most valuable interactions, or identifying which parameter combinations correlate with successful outcomes.

The session continuity framework is particularly valuable in scenarios where users do not complete their intended actions in a single uninterrupted session but instead interact with the platform across multiple touchpoints over extended periods. A user might initially visit a landing page from a campaign link but close the browser without taking action, then later respond to a follow-up message delivered as part of step 1204, and that message response can be correctly attributed back to the original landing page session through the session linkage mechanisms described. A user might begin an interaction on a landing page, trigger a communication that fails on the initial protocol attempt at decision point 1206 but succeeds after fallback at step 1207, respond to that communication hours later, and have that delayed response still correctly correlated with the original page context through the preserved session ID. An agent might receive a callback request days after the user activated the control at step 1203, and the agent platform can retrieve the complete landing page context including what campaign was running, what product the user viewed, and what specific page control the user activated, all through the session record linkage. These scenarios demonstrate that the disclosed session continuity architecture enables the landing page to function not as an isolated web destination but as the persistent orchestration hub for extended multi-channel user journeys, with the session identifier serving as the durable link binding together all interaction phases regardless of temporal gaps, channel transitions, or technical adaptations.

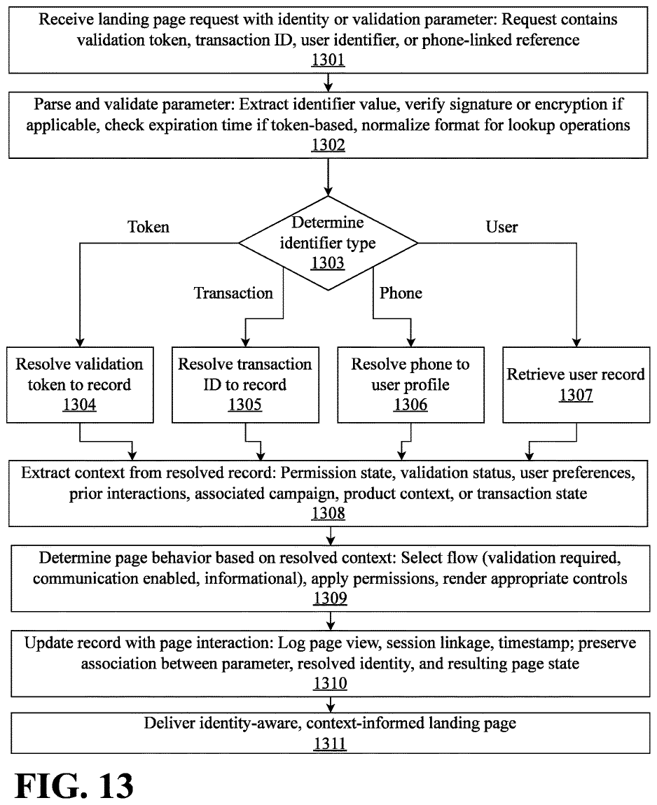

FIG. 13 is a method diagram illustrating identity-linked and validation-linked parameter resolution using one or more identifiers including phone number, transaction-linked identifier, validation token, or user-associated record references according to a preferred embodiment. The diagram depicts the comprehensive resolution workflow by which parameter values referencing users, transactions, or validation states are interpreted, dereferenced, enriched with contextual data, and ultimately transformed into identity-aware page experiences that reflect the specific circumstances and authorization states of individual users.

The process begins at step 1301, where the system receives a landing page request with an identity or validation parameter. The request contains a validation token serving as a cryptographically signed or encrypted reference to a pending validation requirement, a transaction ID linking the request to a specific business transaction such as an order, appointment, inquiry, or service request, a user identifier such as a UUID or internal account reference directly identifying a user profile, or a phone-linked reference such as a phone number or hash thereof that serves as a stable identifier anchoring a persistent user identity. These parameter types share the common characteristic that they reference stored contextual data about specific individuals or specific interaction instances rather than merely identifying abstract campaigns or products, enabling the system to deliver experiences that are personalized and contextualized based on who the user is and what prior relationship or pending transaction applies.

At step 1302, the system performs parameter parsing and validation operations. The system extracts the identifier value from the request parameter, removing any encoding, escaping, or formatting artifacts introduced by URL encoding or other transport mechanisms. If the parameter is a signed or encrypted token, the system verifies the signature or performs decryption to confirm authenticity and prevent tampering, ensuring that the token was issued by a trusted authority and has not been modified in transit. If the parameter is token-based with an embedded expiration time, the system checks whether the current timestamp falls within the token's validity window, rejecting expired tokens to prevent stale validation references or outdated transaction links from being honored beyond their intended lifetime. The system normalizes the identifier format for lookup operations, converting phone numbers to canonical E.164 format, standardizing UUID representations, or applying other normalization rules that ensure successful datastore lookups regardless of formatting variations in the incoming parameter. This parsing and validation step transforms the raw parameter string into a verified, normalized, and trustworthy identifier ready for resolution against persistent records.

The process reaches decision point 1303, which determines the identifier type by examining the structure, prefix, or semantic characteristics of the validated parameter. The determination classifies the identifier as belonging to one of several categories: a validation token typically identified by specific prefixes, signature structures, or registration in a token issuance system; a transaction ID typically formatted according to transaction identifier schemes and resolvable through transaction datastore lookups; a phone number identified by numeric structure, country code prefixes, and length conforming to telephony standards; or a user record identifier such as a UUID that directly references a user profile through primary key lookup. This classification determines which resolution path the system will follow to retrieve the appropriate contextual record.

If the identifier type is determined to be a validation token, the process follows the “Token” branch to step 1304, where the system resolves the validation token to a record by performing a datastore lookup using the token value as a key. The retrieved validation record contains information about the pending validation requirement including what identity verification, consent collection, transaction confirmation, or approval workflow must be completed, the current status indicating whether validation is pending, in progress, completed, or expired, the associated user identity if the validation is linked to a specific user profile, temporal constraints such as when the validation opportunity expires or when the validation was initiated, and any collected validation data such as confirmed information, uploaded documents, or approval decisions made during prior validation attempts. The validation record provides the system with a complete understanding of what gating conditions apply to the current page request and whether the user has satisfied prerequisites necessary for accessing certain page modes or actions.

If the identifier type is a transaction ID, the process follows the “Transaction” branch to step 1305, where the system resolves the transaction ID to a record by querying the transaction datastore. The retrieved transaction record contains comprehensive information about the business transaction including the transaction type such as purchase, appointment, service request, or inquiry, the transaction state indicating whether the transaction is pending, confirmed, completed, canceled, or in another lifecycle stage, the products or services involved in the transaction, the associated user identity linking the transaction to a specific customer or prospect, temporal information such as when the transaction was created and when it is scheduled to occur or complete, and transaction-specific data such as order details, appointment times, selected options, or collected requirements. The transaction record enables the system to present landing pages that are specifically contextualized to the transaction, showing transaction-relevant information, offering transaction-specific actions, and maintaining continuity with prior transaction-related interactions.

If the identifier type is a phone number, the process follows the “Phone” branch to step 1306, where the system resolves the phone number to a user profile by looking up the normalized phone number in the user identity datastore. The phone number serves as a stable anchor for persistent identity, enabling recognition of returning users across multiple campaigns, devices, or interaction touchpoints. The retrieved user profile contains comprehensive accumulated data about the individual including their identity information such as name and contact preferences where collected, interaction history documenting prior engagements with the platform including page visits, communications, transactions, and downstream interactions, opt-in state recording what communication permissions have been granted including channel preferences and topic restrictions, device associations linking the user to specific devices or browsers enabling device-specific optimizations, loyalty status such as rewards program membership or tier, preference settings for communication frequency, content types, or interaction modes, and prior session records enabling recognition of returning users and continuity with prior unfinished workflows. The phone-anchored user profile provides rich personalization context enabling the system to tailor the landing page experience based on accumulated knowledge about the user.

If the identifier type is a direct user record reference, the process follows the “User” branch to step 1307, where the system directly retrieves the user record using the identifier as a primary key lookup. This path represents the most straightforward resolution scenario where the parameter directly references a user profile without requiring intermediate resolution through phone number matching or token dereferencing. The retrieved user record contains the same categories of information described for step 1306, providing comprehensive user context for page personalization and permission enforcement.

After one of the resolution steps—validation token 1304, transaction ID 1305, phone number 1306, or user record 1307—has been executed, all paths converge at step 1308, where the system extracts context from the resolved record. This extraction operation identifies the salient contextual elements within the retrieved record that should influence page behavior, including permission state indicating what communication or transaction actions are authorized for this user, validation status showing whether gating conditions are satisfied or remain pending, user preferences specifying preferred interaction modes or content types, prior interactions providing historical context such as what products were previously viewed or what communications were previously received, associated campaign information if the validation or transaction record links back to a specific campaign initiative, product context if the transaction or prior interactions involve specific products or services, and transaction state if a transaction record was resolved providing information about pending or completed business activities. The extracted context synthesizes the most relevant elements from what may be a large and complex record structure, distilling that structure into the specific contextual facts that should govern page composition and action availability.

At step 1309, the system determines page behavior based on the resolved context by synthesizing the extracted contextual elements with the interpreted request parameters and applicable flow rules. The determination selects which flow mode is appropriate, such as a validation-required flow if the validation status from step 1308 indicates pending validation, a communication-enabled flow if the permission state indicates that messaging is authorized and no validation barriers exist, or an informational flow if neither direct communication nor gated actions are currently appropriate. The system applies permissions extracted at step 1308 to determine which controls should be rendered in active states, which should be disabled or gated behind additional approval, and which should be suppressed entirely. The system renders appropriate controls by selecting widget types, configurations, and bindings that align with the determined flow mode and permission constraints. This behavioral determination transforms the raw contextual data extracted at step 1308 into executable page composition instructions.

Step 1310 involves updating the record with the page interaction to create a bidirectional linkage between the resolved identity or validation record and the landing page session. The system logs the page view event back to the user record, validation record, or transaction record that was resolved, documenting that this user, validation instance, or transaction was the subject of a landing page interaction. The system records session linkage by storing the session identifier in the user or transaction record, enabling future system operations involving that user or transaction to reference back to this page session. The system captures the timestamp documenting when the page interaction occurred for temporal analysis and session timeout calculations. The system preserves the association between the parameter value that triggered this resolution, the resolved identity or validation context that was retrieved, and the resulting page state that was instantiated, creating an audit trail supporting analytics about which parameter types or resolution paths lead to which page experiences and outcomes. This bidirectional update ensures that identity and transaction records are not merely passive data sources consulted during page composition but rather living interaction histories that accumulate page visit events alongside communication events, transaction events, and downstream system interactions.

At step 1311, the system delivers an identity-aware, context-informed landing page to the user device. This delivered page reflects the complete resolution and synthesis process that preceded it, presenting content, controls, branding, and available actions that are specifically appropriate for the identified user's permission state, validation status, transaction context, and interaction history. The page may include personalized greetings referencing the user's name or prior interactions, transaction-specific information showing order details or appointment times, validation-specific controls for completing pending verification steps, or permission-appropriate communication options offering only the channels and interaction types for which the user has granted consent. The identity-aware, context-informed nature of the delivered page represents the culmination of the resolution process, transforming a parameter string referencing a user, transaction, or validation instance into a fully personalized landing page experience.

The method illustrated in FIG. 13 demonstrates that identity and validation parameter resolution in the disclosed system is not a simple profile lookup operation but rather a comprehensive context retrieval and synthesis process that navigates through multiple record types, extracts salient contextual elements, applies those elements to flow selection and permission enforcement logic, and creates bidirectional linkages ensuring that page interactions are recorded in identity and transaction histories. The multiple resolution paths branching from decision point 1303 reflect the reality that identity and context may be referenced through diverse parameter types including cryptographic tokens, business transaction identifiers, telephony identifiers, or direct database keys, and that the system must be capable of resolving all of these parameter varieties into the rich contextual understanding necessary for identity-aware page composition. The context extraction at step 1308 performs the critical function of distilling complex multi-dimensional user or transaction records into the specific contextual facts relevant to page behavior, preventing the page composition logic from being overwhelmed by the full complexity of user profiles or transaction histories. The page behavior determination at step 1309 demonstrates the synthesis of resolved identity context with flow rules and permission logic, showing how the system transforms knowledge about who the user is and what their authorization state is into concrete decisions about what page to show and what controls to render. The bidirectional record update at step 1310 ensures that the resolution process is not read-only consultation of identity records but rather a reciprocal interaction wherein the landing page visit becomes part of the user's or transaction's interaction history, supporting future recognition, continuity, and attribution.

The identity and validation resolution architecture is particularly valuable in scenarios where landing pages serve as continuation points for interactions initiated through other channels or as entry points linked to specific business transactions. A user who receives an email containing a validation link clicks that link and arrives at the landing page with a validation token parameter; the resolution process retrieves the pending validation requirement, determines what information must be collected or confirmed, and presents a page specifically tailored to completing that validation workflow while recording the page visit in the validation record for audit purposes. A customer who completes a purchase transaction receives a confirmation email containing a transaction-linked landing page URL; when accessed, the resolution process retrieves the transaction details, determines that the transaction is confirmed and pending fulfillment, and presents a page showing order status, expected delivery timeline, and transaction-specific support options while recording the page visit in the transaction record enabling customer service representatives to see that the customer accessed the status page. A returning user whose phone number is recognized through parameter resolution or device fingerprinting is presented with a personalized landing page reflecting their prior interaction history, communication preferences, and loyalty status, with the page visit being logged to their user profile enabling future interactions to benefit from knowledge that the user has now visited this particular campaign page. These scenarios demonstrate that identity and validation parameter resolution transforms landing pages from generic campaign destinations into personalized interaction surfaces that recognize users, respect their authorization states, maintain continuity with prior transactions, and contribute to comprehensive interaction histories spanning multiple channels and touchpoints.

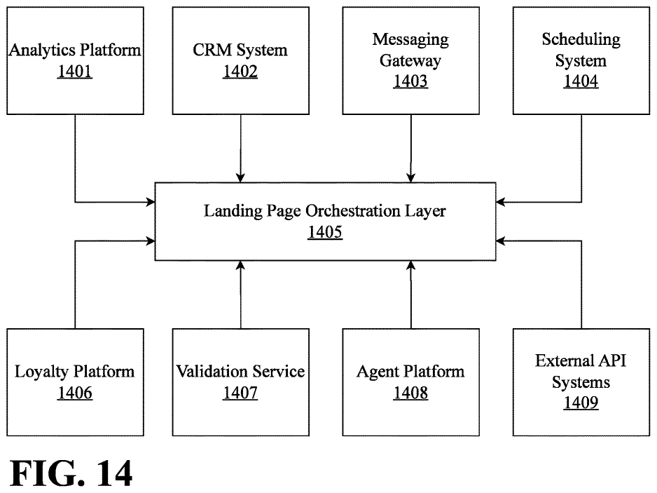

FIG. 14 is a system diagram illustrating exemplary downstream integrations including analytics, loyalty, customer relationship management, scheduling, messaging, and external application programming interface systems according to a preferred embodiment. The diagram depicts the comprehensive ecosystem of external and enterprise systems with which the landing page orchestration layer integrates, demonstrating how page-triggered interactions flow into diverse business systems while preserving attribution, context, and continuity.

At the center of the diagram, a landing page orchestration layer 1405 represents the core platform component responsible for receiving page requests, composing pages, processing user interactions, and coordinating downstream actions as described throughout this disclosure. The landing page orchestration layer 1405 functions as the central integration hub through which user interactions with dynamically composed landing pages are transformed into structured events, records, or API calls delivered to downstream systems. The orchestration layer 1405 maintains responsibility for determining which downstream systems should receive which interactions, what contextual data should accompany those interactions, how session continuity should be preserved across system boundaries, and how attribution data should be structured to enable accurate measurement of landing page effectiveness.

The landing page orchestration layer 1405 integrates with an analytics platform 1401 that receives event tracking data documenting landing page requests, page compositions, user interactions, control activations, communication launches, and downstream routing events. The analytics platform 1401 processes this event stream to generate reports, dashboards, and insights about campaign performance, page effectiveness, user engagement patterns, and conversion attribution. When the landing page orchestration layer 1405 receives a page request, it transmits an event to the analytics platform 1401 documenting the request parameters, resolved campaign and product associations, user identity if available, and selected flow mode, enabling analytics about which parameter combinations drive page traffic. When a user activates a page control, the orchestration layer 1405 transmits a control activation event to the analytics platform 1401 documenting which control was activated, what session it occurred within, and what downstream action resulted, enabling analytics about which page elements drive user engagement. When downstream routing occurs or communications are delivered, the orchestration layer 1405 transmits attribution events to the analytics platform 1401 linking those downstream activities back to the originating page request and control activation, enabling calculation of conversion rates, campaign ROI, and multi-touch attribution across the user journey. The integration with the analytics platform 1401 ensures that all landing page activity is measured and that page performance can be optimized based on quantitative evidence rather than assumptions.

The landing page orchestration layer 1405 integrates with a CRM system 1402 that manages customer and prospect relationships, sales pipelines, service cases, and business opportunities. When a user submits a lead form, requests information, or activates a control indicating interest in products or services, the landing page orchestration layer 1405 creates or updates records in the CRM system 1402 to capture that lead or interest. The transmitted CRM record includes not merely basic contact information but comprehensive contextual enrichment from the landing page session including the campaign that drove the page visit, the specific product or service that was the subject of inquiry, the user's interaction history and prior engagement with the platform, permission state indicating what communication channels are authorized, and the session identifier enabling CRM workflows to reference back to the originating landing page interaction. When a CRM record is created from a landing page interaction, subsequent sales or service activities recorded in the CRM system 1402 can be attributed back to the specific landing page, parameter set, and control activation that initiated the lead, enabling measurement of landing page contribution to closed deals and customer lifetime value. The bidirectional nature of this integration may also allow the landing page orchestration layer 1405 to query the CRM system 1402 during page composition to retrieve existing customer records, enabling personalized page experiences for recognized customers that reflect their current sales pipeline stage, service history, or account status.

The landing page orchestration layer 1405 integrates with a messaging gateway 1403 that handles delivery of communications across multiple protocols and channels including SMS, MMS, RCS, email, and application-based messaging. When a user activates a communication control on a landing page, the orchestration layer 1405 constructs a message artifact and transmits it to the messaging gateway 1403 along with channel selection guidance, capability requirements, session linkage data, and callback or response handling instructions. The messaging gateway 1403 manages the technical complexities of protocol negotiation, carrier routing, delivery status tracking, and response correlation, while the orchestration layer 1405 maintains responsibility for the business logic governing what messages should be sent, when they should be sent, what content they should contain, and how responses should be routed. The integration preserves session continuity by embedding session identifiers in message metadata, enabling user responses received by the messaging gateway 1403 to be correlated back to the originating landing page session and routed to the orchestration layer 1405 for context-aware response processing. The messaging gateway 1403 may also provide delivery status callbacks to the orchestration layer 1405, enabling the platform to detect delivery failures, trigger fallback protocols, update session records with delivery outcomes, and inform analytics about communication effectiveness.

The landing page orchestration layer 1405 integrates with a scheduling system 1404 that manages calendar availability, appointment booking, callback queuing, and temporal coordination of interactions. When a user activates a scheduling control on a landing page requesting an appointment, callback, or time-bound interaction, the orchestration layer 1405 transmits a scheduling request to the scheduling system 1404 including the user's contact information, preferred time slots or callback windows, the subject matter or purpose of the scheduled interaction, the campaign and product context from the landing page session, and any agent requirements or routing preferences derived from campaign rules. The scheduling system 1404 processes the request by checking availability, reserving time slots, creating calendar entries, and potentially notifying agents or representatives of upcoming scheduled interactions. The integration maintains session linkage so that when the scheduled time arrives and the interaction occurs, the agent or representative can access the full landing page context including what page the user viewed, what control they activated, and what campaign drove their interest, enabling more informed and contextually appropriate engagement. Bidirectional integration may allow the scheduling system 1404 to send confirmation or reminder communications through the orchestration layer 1405, ensuring that all user communications maintain consistent branding and session continuity.

The landing page orchestration layer 1405 integrates with a loyalty platform 1406 that manages rewards programs, point balances, tier status, offer eligibility, and redemption workflows. When a user activates a loyalty-related control on a landing page such as a rewards redemption button or points inquiry widget, the orchestration layer 1405 queries the loyalty platform 1406 to retrieve the user's current loyalty status, available offers, point balance, and redemption options, then presents that information within the landing page or executes redemption transactions as requested by the user. The integration enables landing pages to serve as loyalty engagement surfaces where users can check their status, redeem rewards, or respond to loyalty-exclusive offers while maintaining the parameter-driven, dynamically composed characteristics of the disclosed system. Loyalty status retrieved from the loyalty platform 1406 may also influence page composition decisions independent of explicit loyalty controls; for example, high-tier loyalty members might be presented with enhanced communication options or expedited service pathways even when accessing general campaign pages. The integration maintains session linkage so that loyalty redemptions or inquiries initiated from landing pages are recorded in loyalty transaction histories with full attribution to the originating campaign and page session.

The landing page orchestration layer 1405 integrates with a validation service 1407 that performs identity verification, document authentication, fraud detection, age verification, address validation, or other confirmation workflows required by business rules or regulatory requirements. When a user reaches a landing page with a validation token parameter indicating pending validation, or when page rules require validation before certain actions can proceed, the orchestration layer 1405 coordinates with the validation service 1407 to present validation workflows, collect required information or documentation, submit validation requests, and retrieve validation outcomes. The validation service 1407 may employ various verification methods including knowledge-based authentication questions, document image analysis, database cross-reference checks, biometric verification, or third-party identity verification APIs, with the specific methods determined by validation requirements and risk assessment. The orchestration layer 1405 maintains validation state in session records and user records, enabling subsequent page interactions to recognize that validation has been completed and to unlock previously gated actions or page modes. The integration ensures that validation workflows are seamlessly embedded within landing page experiences rather than requiring redirection to separate validation applications, preserving user experience continuity and maintaining session-based correlation between validation outcomes and the page interactions they gate.

The landing page orchestration layer 1405 integrates with an agent platform 1408 that manages human agent availability, task queuing, conversation routing, and agent-customer interactions. When a user activates a control requesting agent assistance, callback, or live chat, the orchestration layer 1405 transmits an agent request to the agent platform 1408 including the user's contact information, the subject matter or reason for agent assistance, the full landing page context including campaign, product, and user profile information, priority or urgency indicators derived from campaign rules or user tier, and session linkage enabling the eventual agent interaction to reference the originating page session. The agent platform 1408 processes the request by checking agent availability, applying routing rules to assign the request to an appropriate agent or team based on specialization or geographic factors, queueing the request if immediate assignment is not possible, and eventually connecting the user with an agent through phone call, live chat, video session, or another interaction modality. The integration maintains rich context transfer so that when an agent accepts a request originating from a landing page, the agent's console displays comprehensive information about what page the user viewed, what campaign drove their visit, what specific control they activated, and what user profile or transaction history applies, enabling the agent to engage knowledgeably without requiring the user to repeat information already provided through the landing page interaction. Bidirectional integration may enable agents to trigger follow-up communications or page invitations through the orchestration layer 1405, maintaining consistent session tracking and attribution across agent-initiated and page-initiated touchpoints.

The landing page orchestration layer 1405 integrates with external API systems 1409 representing diverse third-party services, partner platforms, industry-specific integrations, or client-custom systems that may receive page-triggered interactions or provide data influencing page composition. These external API systems 1409 might include payment processors for transaction-related landing pages, inventory systems for availability checking and real-time offer presentation, shipping carriers for delivery estimation and tracking, mapping services for location-based page customization, authentication providers for federated identity resolution, compliance platforms for regulatory requirement checking, or industry-vertical-specific systems such as hospitality property management systems, healthcare EHR platforms, or automotive dealership management systems. The orchestration layer 1405 invokes these external API systems 1409 through standardized integration patterns including RESTful API calls, webhook subscriptions, message queue integrations, or data synchronization mechanisms, with each integration adapted to the technical requirements and data models of the specific external system. The external API integrations 1409 extend the capability of the landing page orchestration layer 1405 beyond the boundaries of platform-native functionality, enabling landing pages to serve as the user-facing layer for complex multi-system workflows while maintaining the platform's responsibility for session management, attribution tracking, and user experience consistency.

The architecture illustrated in FIG. 14 demonstrates that the disclosed landing page orchestration layer 1405 functions not as an isolated web page rendering system but as a comprehensive integration hub that coordinates data flows among diverse business systems while maintaining central responsibility for user experience, session continuity, and attribution integrity. The breadth of integrations spanning analytics 1401, CRM 1402, messaging 1403, scheduling 1404, loyalty 1406, validation 1407, agent platforms 1408, and external APIs 1409 reflects the reality that modern digital engagement strategies require landing pages to serve as orchestration surfaces for multi-system workflows rather than as simple lead capture forms or informational destinations. Each integration preserves rich contextual data flowing from the landing page session to downstream systems, ensuring that those systems receive not merely notification that an interaction occurred but comprehensive attribution data, user profile enrichment, campaign context, and session linkage enabling downstream activities to be executed knowledgeably and attributed accurately. The bidirectional potential of these integrations enables downstream systems to inform landing page composition through data retrieved during page load or to trigger follow-on landing page interactions through callbacks or event notifications, creating feedback loops that enhance personalization and maintain cross-system consistency. The central positioning of the landing page orchestration layer 1405 in this integration architecture emphasizes its role as the coordination point through which user-initiated actions are transformed into structured system interactions while preserving the parameter-driven, identity-aware, permission-gated characteristics that define the disclosed invention.

The downstream integration ecosystem supports sophisticated use cases that would be impossible with conventional landing page systems lacking comprehensive integration capabilities. A user visits a campaign landing page, activates a scheduling control, books an appointment through integration with the scheduling system 1404, receives confirmation through the messaging gateway 1403, has their CRM record updated to reflect the scheduled appointment through integration with the CRM system 1402, accrues loyalty points for booking through integration with the loyalty platform 1406, and generates analytics events documenting the conversion path through integration with the analytics platform 1401, all while the landing page orchestration layer 1405 maintains the session thread linking these disparate system activities back to the originating page request and enabling holistic measurement of the landing page's contribution to the business outcome. An existing customer recognized through identity parameter resolution is presented with a loyalty-enhanced landing page experience informed by queries to the loyalty platform 1406 and CRM system 1402, activates an agent request control that routes through the agent platform 1408 with full context about the customer's history and current loyalty tier, and engages in an agent conversation that results in a transaction processed through external API systems 1409 with all activities recorded in the CRM system 1402 and measured through the analytics platform 1401 with attribution to the originating campaign and landing page session. These scenarios demonstrate that the disclosed downstream integration architecture enables landing pages to function as the user-facing orchestration layer for complex multi-system business processes while maintaining the system's core capabilities for parameter-driven composition, identity awareness, permission enforcement, and session continuity across all integrated touchpoints.

### Exemplary Computing Environment

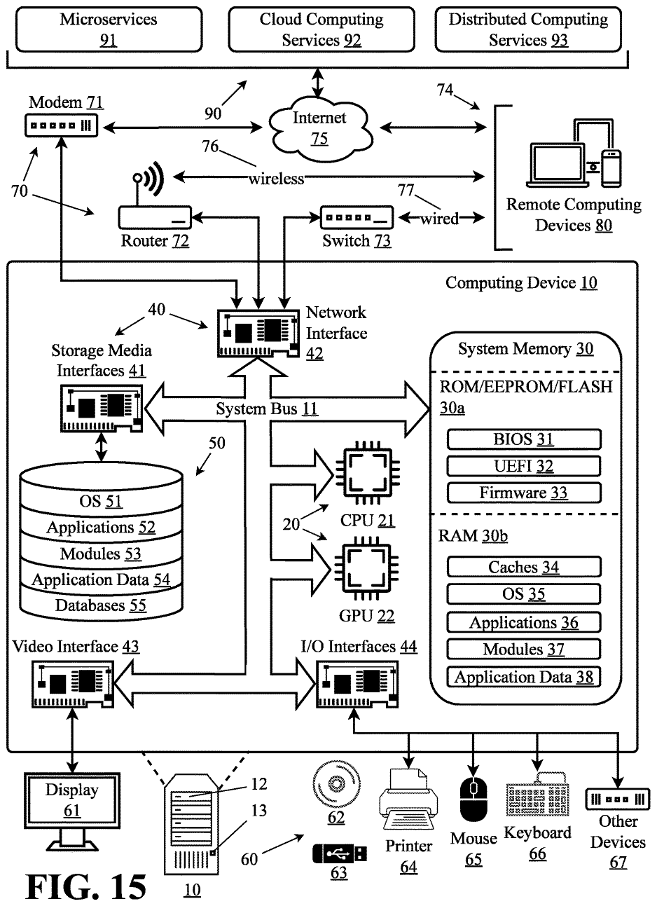

FIG. 15 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containers.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a container file or similar, which contains instructions for assembling the image. Container files are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containers provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for parameter-driven dynamic landing page communication orchestration, comprising:
one or more computing devices configured to:
receive a page request from a user device, wherein the page request comprises one or more runtime parameters selected from the group consisting of campaign identifiers, product identifiers, validation tokens, client identifiers, user-associated identifiers, transaction-linked identifiers, and session identifiers;
interpret the one or more runtime parameters by resolving said parameters into runtime associations comprising at least one of campaign associations, product contexts, client-specific configurations, validation states, or user-linked records through retrieval of corresponding records from one or more datastores;
dynamically compose a landing page by selecting a page template, inserting content fragments based on the runtime associations, applying branding assets according to client-specific configuration, rendering one or more interactive controls appropriate for the runtime associations, and binding the one or more interactive controls to backend actions according to applicable rule sets, wherein the dynamically composed landing page varies based on the runtime parameters while being served from a single landing page endpoint;
determine whether page-triggered actions are authorized by evaluating permission states and opt-in status associated with user identity profiles;
assess available communication channels based on device capability, carrier support, and protocol availability;
assign session identifiers linking page requests, user interactions, communication launches, and downstream routing events into persistent session records;
initiate communications over selected channels based on permission determinations and channel availability assessments, wherein communications preserve session context through embedded session identifiers; and
route page-triggered interactions to downstream systems with session identifiers, campaign attribution data, and user context;
wherein the one or more computing devices are configured to support multiple distinct interaction flows from the single landing page endpoint by determining runtime page behavior based on the runtime associations, retrieved contextual records, permission determinations, and channel eligibility assessments, thereby enabling a shared technical infrastructure to serve multiple campaigns, clients, and user contexts without requiring separate hard-coded landing pages for each interaction scenario.

2. The system of claim 1, wherein interpreting the one or more runtime parameters further comprises:
parsing parameter values from query strings, path segments, tokens, cookies, or headers;
validating cryptographic signatures or decrypting encrypted tokens to verify parameter authenticity;
checking expiration times on token-based parameters and rejecting expired tokens;
normalizing parameter formats into canonical representations for datastore lookup operations; and
translating client-specific parameter vocabularies into platform-standard schemas to support white-label deployment wherein different clients employ different outward-facing parameter naming conventions while sharing common internal parameter interpretation logic.

3. The system of claim 1, wherein dynamically composing the landing page further comprises:
evaluating flow rules retrieved from campaign records to determine an initial flow mode selected from product inquiry flow, validation-linked flow, scheduling flow, communication-launch flow, and default informational flow;
conditionally rendering or suppressing interactive controls based on permission states and validation states;
applying widget definitions specifying visual presentation, configuration parameters, and action binding templates for interactive controls; and
producing a runtime page state object comprising selected template identifier, inserted content fragments, applied branding profile, rendered controls with their configurations, permission constraints governing each control, and action bindings linking controls to backend actions.

4. The system of claim 1, wherein the one or more computing devices are further configured to:
maintain phone-number-anchored user profiles wherein phone numbers serve as stable identifiers for persistent identity across multiple campaigns, devices, and interaction touchpoints;
accumulate interaction history documenting prior page visits, communications, transactions, and downstream system interactions associated with each user profile;
store opt-in state information indicating granted communication permissions including channel preferences, topic restrictions, and temporal consent boundaries; and
provide user profile data during parameter interpretation, enabling personalized page composition based on accumulated user context.

5. The system of claim 4, wherein the one or more computing devices are further configured to:
resolve user-associated parameters comprising phone numbers, user identifiers, or transaction-linked identifiers to corresponding user profiles;
extract permission state, validation status, user preferences, prior interactions, and associated campaign context from resolved user profiles;
determine page behavior by selecting flow modes, applying permissions, and rendering controls based on extracted user context; and
update user profiles with page interaction events including page view timestamps, session linkage, activated controls, and resulting actions, thereby creating bidirectional association between user profiles and landing page sessions.

6. The system of claim 1, wherein managing session continuity further comprises:
creating new session identifiers for initial page requests or retrieving existing session identifiers for returning users;
storing session records comprising session identifier, parameter state, page template selected, controls rendered, identity context, permission state, timestamp, and initial flow selection;
updating session records to log user interactions including control activations, channel selections, protocol adaptations, message identifiers, downstream routing events, and communication outcomes;
preserving session continuity across messaging handoffs by embedding session identifiers in message metadata or headers enabling correlation of user responses with originating page sessions; and
maintaining session linkage across protocol fallback events wherein communication delivery failures trigger alternate channel selection while preserving the same session identifier and interaction context.

7. The system of claim 6, wherein initiating communications further comprises:
receiving communication initiation requests from page controls activated by users;
verifying that communication is authorized for the requesting user based on permission state evaluation;
determining available communication protocols including Short Message Service (“SMS”), Multimedia Messaging Service (“MMS”), Rich Communication Services (“RCS”), email, web-based messaging, and application messaging;
constructing richer message formats comprising branded cards, interactive buttons, media content, and structured layouts when channel assessment indicates richer protocol support;
constructing fallback message formats comprising plain text or basic formatting when channel assessment indicates limited protocol support;
delivering communications via selected channels with embedded session identifiers enabling response correlation; and
initiating fallback protocol delivery while preserving session identifier when initial communication delivery encounters protocol or channel failures.

8. The system of claim 1, wherein the one or more computing devices implement a white-label deployment architecture by:
receiving page requests from multiple client domains;
retrieving client-specific configurations comprising client-specific branding assets, template preferences, parameter vocabulary mappings, business rule overrides, and downstream destination specifications based on client identifiers in request parameters or domain names;
applying client-specific branding, selecting client-preferred templates, evaluating client-specific rules, and routing interactions to client-specific downstream destinations; and
thereby enabling multiple clients to receive distinct branded experiences while sharing common parameter interpretation, page composition, permission enforcement, and session management infrastructure.

9. The system of claim 1, wherein routing page-triggered interactions to downstream systems comprises transmitting data to:
an analytics platform for receiving event tracking data documenting page requests, user interactions, control activations, communication launches, and downstream routing events, wherein each event includes session identifier and campaign attribution data enabling calculation of conversion rates and multi-touch attribution;
a customer relationship management system for receiving lead records and contact records enriched with campaign context, product associations, user profiles, permission states, and session identifiers;
a scheduling system for receiving appointment booking requests and callback requests with user contact information, preferred time slots, subject matter context, and session linkage;
an agent platform for receiving agent assistance requests with landing page context including campaign details, user profile information, interaction history, and session identifiers; and
a validation service for performing identity verification, document authentication, or approval workflows, wherein validation outcomes are returned to update validation states and unlock gated page modes or actions.

10. The system of claim 1, wherein the one or more computing devices are further configured to:
process secondary flow initiation events when users activate rendered controls after initial page load;
retrieve updated permission states, validation statuses, and channel eligibility assessments at time of control activation to ensure authorization decisions reflect current state;
determine secondary flow type from control identifier and context, classifying flows as communication initiation, validation collection, scheduling request, downstream routing, or other secondary actions;
execute permission checks and capability assessments before proceeding with secondary flow actions;
attach context and attribution data to downstream routing events including session identifiers, campaign identifiers, parameter state, user record references, control identifiers, and routing provenance; and
preserve session continuity by updating session records with secondary flow events and maintaining session linkage when interactions transition to messaging channels, agent platforms, or external business systems.

11. A method for parameter-driven dynamic landing page communication orchestration, comprising the steps of:
receiving a page request from a user device, wherein the page request comprises one or more runtime parameters selected from the group consisting of campaign identifiers, product identifiers, validation tokens, client identifiers, user-associated identifiers, transaction-linked identifiers, and session identifiers, using a computing device;
interpreting the one or more runtime parameters by resolving said parameters into runtime associations comprising at least one of campaign associations, product contexts, client-specific configurations, validation states, or user-linked records through retrieval of corresponding records from one or more datastores, using a computing device;
dynamically composing a landing page by selecting a page template, inserting content fragments based on the runtime associations, applying branding assets according to client-specific configuration, rendering one or more interactive controls appropriate for the runtime associations, and binding the one or more interactive controls to backend actions according to applicable rule sets, wherein the dynamically composed landing page varies based on the runtime parameters while being served from a single landing page endpoint, using a computing device;
determining whether page-triggered actions are authorized by evaluating permission states and opt-in status associated with user identity profiles, using a computing device;
assessing available communication channels based on device capability, carrier support, and protocol availability, using a computing device;
assigning session identifiers linking page requests, user interactions, communication launches, and downstream routing events into persistent session records, using a computing device;
initiating communications over selected channels based on permission determinations and channel availability assessments, wherein communications preserve session context through embedded session identifiers, using a computing device;
routing page-triggered interactions to downstream systems with session identifiers, campaign attribution data, and user context, using a computing device; and
supporting multiple distinct interaction flows from the single landing page endpoint by determining runtime page behavior based on the runtime associations, retrieved contextual records, permission determinations, and channel eligibility assessments, thereby enabling a shared technical infrastructure to serve multiple campaigns, clients, and user contexts without requiring separate hard-coded landing pages for each interaction scenario, using a computing device.

12. The method of claim 11, wherein interpreting the one or more runtime parameters further comprises the steps of:
parsing parameter values from query strings, path segments, tokens, cookies, or headers;
validating cryptographic signatures or decrypting encrypted tokens to verify parameter authenticity;
checking expiration times on token-based parameters and rejecting expired tokens;
normalizing parameter formats into canonical representations for datastore lookup operations; and
translating client-specific parameter vocabularies into platform-standard schemas to support white-label deployment wherein different clients employ different outward-facing parameter naming conventions while sharing common internal parameter interpretation logic.

13. The method of claim 11, wherein dynamically composing the landing page further comprises the steps of:
evaluating flow rules retrieved from campaign records to determine an initial flow mode selected from product inquiry flow, validation-linked flow, scheduling flow, communication-launch flow, and default informational flow;
conditionally rendering or suppressing interactive controls based on permission states and validation states;
applying widget definitions specifying visual presentation, configuration parameters, and action binding templates for interactive controls; and
producing a runtime page state object comprising selected template identifier, inserted content fragments, applied branding profile, rendered controls with their configurations, permission constraints governing each control, and action bindings linking controls to backend actions.

14. The method of claim 11, further comprising the steps of:
maintaining phone-number-anchored user profiles wherein phone numbers serve as stable identifiers for persistent identity across multiple campaigns, devices, and interaction touchpoints, using a computing device;
accumulating interaction history documenting prior page visits, communications, transactions, and downstream system interactions associated with each user profile, using a computing device;
storing opt-in state information indicating granted communication permissions including channel preferences, topic restrictions, and temporal consent boundaries, using a computing device; and
providing user profile data during parameter interpretation, enabling personalized page composition based on accumulated user context, using a computing device.

15. The method of claim 14, further comprising the steps of:
resolving user-associated parameters comprising phone numbers, user identifiers, or transaction-linked identifiers to corresponding user profiles, using a computing device;
extracting permission state, validation status, user preferences, prior interactions, and associated campaign context from resolved user profiles, using a computing device;
determining page behavior by selecting flow modes, applying permissions, and rendering controls based on extracted user context, using a computing device; and
updating user profiles with page interaction events including page view timestamps, session linkage, activated controls, and resulting actions, thereby creating bidirectional association between user profiles and landing page sessions, using a computing device.

16. The method of claim 11, wherein managing session continuity further comprises the steps of:
creating new session identifiers for initial page requests or retrieving existing session identifiers for returning users;
storing session records comprising session identifier, parameter state, page template selected, controls rendered, identity context, permission state, timestamp, and initial flow selection;
updating session records to log user interactions including control activations, channel selections, protocol adaptations, message identifiers, downstream routing events, and communication outcomes;
preserving session continuity across messaging handoffs by embedding session identifiers in message metadata or headers enabling correlation of user responses with originating page sessions; and
maintaining session linkage across protocol fallback events wherein communication delivery failures trigger alternate channel selection while preserving the same session identifier and interaction context.

17. The method of claim 16, wherein initiating communications further comprises the steps of:
receiving communication initiation requests from page controls activated by users;
verifying that communication is authorized for the requesting user based on permission state evaluation;
determining available communication protocols including SMS, MMS, RCS, email, web-based messaging, and application messaging;
constructing richer message formats comprising branded cards, interactive buttons, media content, and structured layouts when channel assessment indicates richer protocol support;
constructing fallback message formats comprising plain text or basic formatting when channel assessment indicates limited protocol support;
delivering communications via selected channels with embedded session identifiers enabling response correlation; and
initiating fallback protocol delivery while preserving session identifier when initial communication delivery encounters protocol or channel failures.

18. The method of claim 11, further comprising the steps of:
receiving page requests from multiple client domains;
retrieving client-specific configurations comprising client-specific branding assets, template preferences, parameter vocabulary mappings, business rule overrides, and downstream destination specifications based on client identifiers in request parameters or domain names;
applying client-specific branding, selecting client-preferred templates, evaluating client-specific rules, and routing interactions to client-specific downstream destinations; and
thereby enabling multiple clients to receive distinct branded experiences while sharing common parameter interpretation, page composition, permission enforcement, and session management infrastructure.

19. The method of claim 11, wherein routing page-triggered interactions to downstream systems comprises transmitting data to:
an analytics platform for receiving event tracking data documenting page requests, user interactions, control activations, communication launches, and downstream routing events, wherein each event includes session identifier and campaign attribution data enabling calculation of conversion rates and multi-touch attribution;
a customer relationship management system for receiving lead records and contact records enriched with campaign context, product associations, user profiles, permission states, and session identifiers;
a scheduling system for receiving appointment booking requests and callback requests with user contact information, preferred time slots, subject matter context, and session linkage;
an agent platform for receiving agent assistance requests with landing page context including campaign details, user profile information, interaction history, and session identifiers; and
a validation service for performing identity verification, document authentication, or approval workflows, wherein validation outcomes are returned to update validation states and unlock gated page modes or actions.

20. The method of claim 11, further comprising the steps of:
processing secondary flow initiation events when users activate rendered controls after initial page load, using a computing device;
retrieving updated permission states, validation statuses, and channel eligibility assessments at time of control activation to ensure authorization decisions reflect current state, using a computing device;
determining secondary flow type from control identifier and context, classifying flows as communication initiation, validation collection, scheduling request, downstream routing, or other secondary actions, using a computing device;
executing permission checks and capability assessments before proceeding with secondary flow actions, using a computing device;
attaching context and attribution data to downstream routing events including session identifiers, campaign identifiers, parameter state, user record references, control identifiers, and routing provenance, using a computing device; and
preserving session continuity by updating session records with secondary flow events and maintaining session linkage when interactions transition to messaging channels, agent platforms, or external business systems, using a computing device.
